(19) United States
(12) Patent Application Publication
(10) Pub. No.: US 2025/0033328 A1
(43) Pub. Date: Jan. 30, 2025

(54) ALTERNATIVE BUILDING MATERIAL AND METHOD OF MANUFACTURING THEREOF

(71) Applicant: Plantd, Inc., Oxford, NC (US)

(72) Inventors: Huade Tan, Oxford, NC (US); Josh Dorfman, Oxford, NC (US); Nathanial Levi Silvernail, Oxford, NC (US)

(73) Assignee: Plantd, Inc., Oxford, NC (US)

(21) Appl. No.: 18/918,560

(22) Filed: Oct. 17, 2024

Related U.S. Application Data
(63) Continuation-in-part of application No. 18/339,798, filed on Jun. 22, 2023.
(60) Provisional application No. 63/356,806, filed on Jun. 29, 2022.
(60) Provisional application No. 63/441,113, filed on Jan. 25, 2023.
(60) Provisional application No. 63/592,831, filed on Oct. 24, 2023.

(51) Int. Cl. B32B 21/02; B32B 3/06

(52) U.S. Cl. CPC B32B 21/02; B32B 3/06; B32B 2307/72

(57) ABSTRACT

In variants, an alternative building material can include a binding agent and a plurality of strands of a raw material. In variants, the building material can be formed into a variety of form factors, including: panels, dimensional building material (e.g., 2×4, 2×6, etc.), cladding, sheeting, and/or other materials. Systems and methods for the composition, manufacture, and applications of an alternative building material are disclosed herein.

### CROSS-REFERENCE TO RELATED APPLICATIONS

This application is a continuation in part of U.S. application Ser. No. 18/339,798 filed 22 Jun. 2023, which claims the benefit of U.S. Provisional Application No. 63/356,806, filed 29 Jun. 2022, and of U.S. Provisional Application No. 63/441,113, filed 25 Jan. 2023, each of which is incorporated in its entirety by this reference.

This application claims the benefit of U.S. Provisional Application No. 63/592,831, filed 24 Oct. 2023, which is incorporated in its entirety by this reference.

### TECHNICAL FIELD

This invention relates generally to the building material field, and more specifically to a new and useful alternative building material in the building material field.

### BRIEF DESCRIPTION OF THE FIGURES

FIG. 1 is a schematic representation of a variant of the method for manufacturing an alternative building material.

FIGS. 2A and 2B are examples of products made by the method of FIG. 1.

FIG. 3 is an example of a variant of requirements for a variant of the alternative building material.

FIG. 4A is a variant of sections of a raw material.

FIG. 4B is a variant of strands of a raw material.

FIG. 5A depicts a variant of a former.

FIG. 5B depicts variants of forming heads.

FIG. 5C depicts a variant of formed strands of the raw material.

FIGS. 6-8 depict variants of the method for manufacturing an alternative building material.

FIG. 9 is an example of a building constructed using the alternative building material.

FIG. 10 is an example of a comparison of the strand density in a cross section of the raw material as compared to OSB.

FIG. 11 is an example of test results and a test configuration for a transverse uniform test for the alternative building material.

FIG. 12 is an example of test results and a test configuration for a lateral shear test for the alternative building material.

FIG. 13 is an example of test results and a test configuration for a flexural strength test for the alternative building material.

FIG. 14 is an example of test results and a test configuration for a flexural stiffness test for the alternative building material.

FIG. 15 is an example of test results and a test configuration for an axial tension test for the alternative building material.

FIG. 16 is an example of test results and a test configuration for a dowel bearing strength test for the alternative building material.

FIG. 17 is an example of test results and a test configuration for a nail withdrawal and head pull through test for the alternative building material.

FIG. 18 is an example of test results for a panel flexure negative pressure test for the alternative building material.

FIG. 19 is an example of test results for a panel flexure positive pressure test for a roof decking embodiment of the alternative building material.

FIG. 20 is an example of test results for a panel flexure positive pressure test for a wall panel embodiment of the alternative building material.

FIG. 21 is an example of test results for a lateral wall test for the alternative building material.

FIG. 22 is an example of test results for a cyclic lateral wall test for the alternative building material.

FIG. 23A is an example of a variant of a stranding device.

FIG. 23B a perspective view of a blade securing mechanism of a drum of the stranding device of FIG. 23A.

FIGS. 24A-24D depict a cross-sectional view, top view, side view, and front view, respectively, of a variant of a stranding device.

FIG. 25 is an example of a mixing device.

FIG. 26 is an example of strands of raw material.

FIGS. 27A and 27B are examples of pressing the mixture.

FIGS. 28A-28D are examples of pressing the mixture into a building material, removing the pressed building material, a protective layer coating the pressed building material, and removing the protective layer, respectively.

FIGS. 29A and 29B are examples of post-processing.

FIG. 30 is an illustrative example of a variant of a press.

FIG. 31 is an illustrative example of a variant of a system for manufacturing the building material.

FIGS. 32A and 32B are illustrative examples of variants of a system for manufacturing the building material.

FIG. 33A is an example of a 3-point bend test conducted using OSB.

FIG. 33B is an example of an internal bond test conducted using OSB.

FIG. 33C is an example of a swell test conducted using OSB.

FIGS. 34A and 34B are schematic representations of examples of a single-layer building material and a two-layer building material, respectively, each with substantially isotropically oriented strands.

FIGS. 35A and 35B are schematic representations of examples of building materials with oriented strands.

FIG. 36 is a schematic representation of an example of a binding agent applied to a segment of a strand.

FIG. 37 is a schematic representation of an example of a strand.

FIGS. 38A-38C are examples of variants of board composition profiles.

### DETAILED DESCRIPTION

The following description of the embodiments of the invention is not intended to limit the invention to these embodiments, but rather to enable any person skilled in the art to make and use this invention.

### 1. Overview

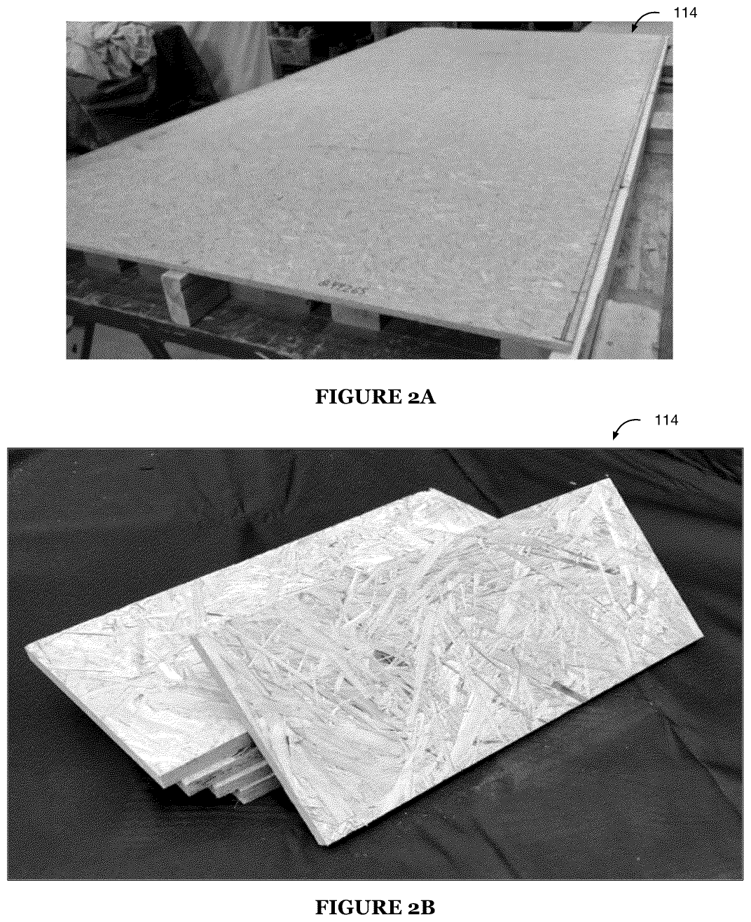

As shown in FIG. 2A, an alternative building material (114) can include a binding agent (108) and a plurality of strands (106) of a raw material (102). In variants, the building material can be formed into a variety of form factors, including: panels, oriented strand board (OSB), medium density fiberboard (MDF), dimensional building material (e.g., 2×4, 2×6, etc.), cladding, sheeting, and/or other materials. Systems and methods for the composition, manufacture, and applications of an alternative building material are disclosed herein.

### 2. Examples

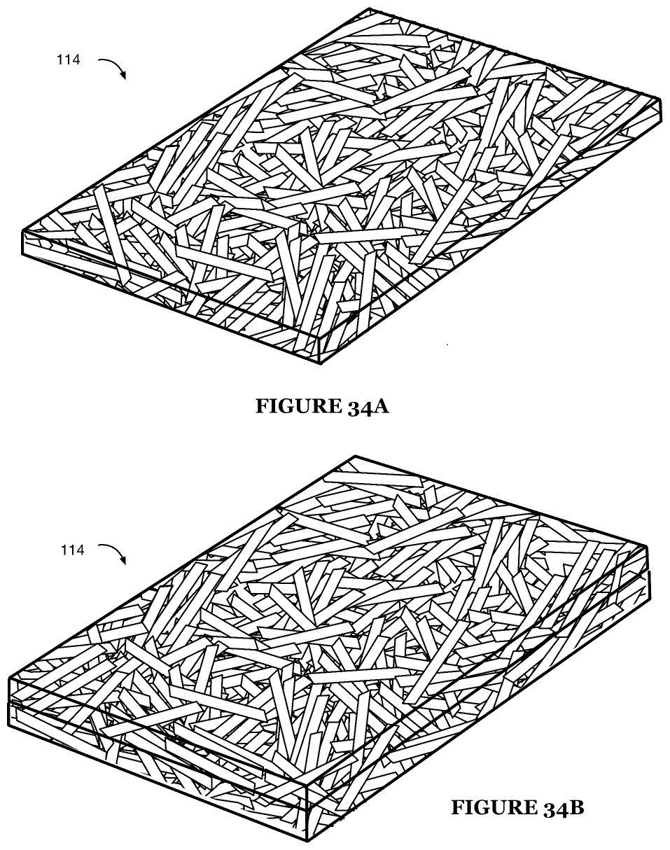

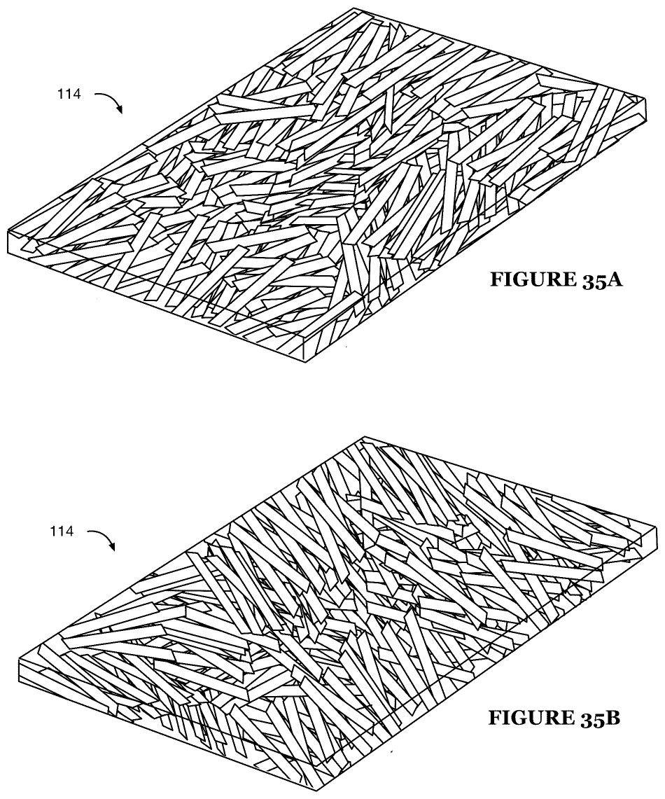

In a first illustrative example, a building material (114) is made from a mixture of a binding agent (108) and a plurality of strands (106) of a raw material (102). The raw material (102) can be a perennial grass, such as Arundo Donax, but can also include bamboo, corn and sugarcane, various perennial reeds, agricultural waste byproducts, and combinations thereof. In a specific example, the building material can consist essentially of monocotyledonous strands bound together by the binding agent. In another specific example, the building material can include monocotyledonous strands bound together by the binding agent, and additionally include other additives, coatings, and/or other materials. The building material (114) can include one or more layers. The strands (106) within the building material (114) (and/or a building material layer) can be oriented or unoriented. In a first example, the building material is a panel formed by mixing the binding agent with a plurality of randomly oriented strands and then compressing the mixture into one or more layers (e.g., examples shown in FIG. 2A, FIG. 2B, FIG. 34A, and FIG. 34B). In a second example, the building material is an oriented strand board (OSB) formed by mixing the binding agent with a plurality of strands, orienting the strands, and then compressing layers of the strands in specific orientations (e.g., examples shown in FIG. 35A and FIG. 35B). The binding agent (108) can be a resin or other binding agent. In examples, the building material can include less than 5% of the binding agent by volume (e.g., a ratio of raw material to binding agent of 20:1 by volume in the final building material) and/or by weight. Each of the strands (106) of the plurality of strands can be between 0.005 inches and 0.025 inches in thickness, inclusive (e.g., 0.01-0.02″, 0.01-0.15″, 0.005-0.25″, etc.), or have any other suitable thickness. Each of the strands (106) of the plurality of strands can be between 4″-18″, inclusive (e.g., 4″-8″, 6″-10″, 8″-12″, 10″-16″, 12″-18″, etc.), or have any other suitable length. Each of the strands (106) of the plurality of strands can be between 0.1″-1″ wide, inclusive (e.g., 0.25-0.75″, 0.5″-1″, etc.), or have any other suitable width. The strands (106) can have an average moisture content between 7-12% by mass, 5%-10% by mass, or any other suitable moisture content. In examples, the building material (114) can be configured to be used in a building application (e.g., in a structurally loaded building application), and/or otherwise used.

In a second illustrative example, a method for manufacturing the building material includes cutting the raw material into billets (e.g., tubular billets), introducing at least one tubular billet of a raw material (102) into a cutting apparatus (104), producing strands (106) of raw material (102) from the tubular billet of raw material using the cutting apparatus (104), applying binding agent (108) to the strands (106) to produce a mixture (110), forming the mixture (110) into a formed mixture with a former (112), pressing the formed mixture into a pressed material, and finishing the pressed material to produce the building material (114). Forming the mixture into a final form can include: optionally aligning the strands (e.g., before or after applying the binding agent), forming the mixture into a mat, compressing the mat, and optionally cutting the compressed mat into a final set of predetermined dimensions. The method can optionally include assembling multiple mats (e.g., layers) into a unitary product (e.g., a multi-layered building material, example shown in FIG. 34B).

### 3. Technical Advantages

Variants of the technology for an alternative building material can confer several benefits over conventional systems and methods.

Variants of the building material described herein can have superior dimensional stability and moisture resistant properties compared to tree-based materials, while being more cost effective to produce, having a smaller carbon footprint and requiring less energy and power to produce.

First, variants of the technology can use fibers from fast growing perennial grass (e.g., Giant Reed, Arundo Donax, bamboo, etc.) to sequester carbon from the atmosphere, and then efficiently turn it into materials for home builders. This enables the system to lock away that carbon in building materials (e.g., the walls, subfloors, and roofs of homes). In an example, variants of the technology can pull about 20 tons of the raw material (e.g., grass) off an acre every year, which can absorb about 25 to 30 tons of atmospheric carbon (e.g., remove 1 mole of carbon dioxide from the atmosphere for every mole of carbon within the alternative building material; sequester 1.2 tons of carbon dioxide for each ton of alternative building material; etc.). That carbon is taken out of the atmosphere as a raw material (e.g., grass), and can be turned into a carbon-neutral or carbon-negative building material. In specific examples, the alternative building material can retain 80% or more of the atmospheric carbon dioxide captured during grass growth and/or captured in the field from which the grass is cultivated (e.g., every 1 lb of the alternative building material retains about 0.8 lb of carbon dioxide that was adsorbed, absorbed, sequestered, or otherwise captured from the atmosphere during raw material growth; 80% carbon efficiency through the production process; etc.). In variants, because of the raw material's efficient growth (e.g., density, speed of growth, resource utilization, etc.), raw material production can require less land. This can enable raw material growth closer to urban areas (e.g., closer to processing and manufacturing plants), thereby resulting in less resource consumption (e.g., land, transportation fuel, etc.) for production.

Second, variants of the technology can create durable building materials that can outperform competitive products (e.g., OSB, MDF, etc.) on key attributes, including strength and moisture resistance. These building materials can be used to build higher performing homes, apartments, or another kind of structure. In variants, these properties can be achieved with or without using chemical or wax additives.

In a first example, the building material can outperform competitive products on moisture resistance by using strands (e.g., with a consistent strand quality) having a thin thickness (e.g., 0.01-0.015 inches) and including a resin fraction (e.g., <5% by volume) sufficient to coat the strands in the building material (e.g., fully coat all strands). Additionally or alternatively, increased moisture resistance can be achieved by using a high density of strands of grass in the board (e.g., between 66-100 strands per inch along the board thickness), and/or otherwise achieved.

In a second example, the building material can outperform competitive products on properties such as strength (e.g., bending strength, ultimate tensile strength) and bending stiffness (e.g., of at least 60,000 lb-in2/ft as determined by ASTM D3043 Method A) by using strands (e.g., with a consistent strand quality) having a thin thickness (e.g., 0.01-0.015 inches) and including a resin fraction (e.g., <5% by mass) sufficient to coat the strands in the building material (e.g., fully coat all strands), by using a random strand orientation, by using a high density of strands of grass in the board (e.g., between 66-100 strands per inch along the board thickness), by using a strand length (e.g., between 4-8 inches) that offers a low thickness to length aspect ratio (e.g., lower than or equal to 1:400), and/or otherwise achieved. The ultimate tensile strength and/or high cell density of the grass fibers (e.g., Arundo Donax) can additionally contribute to bending stiffness.

In a third example, the building material can outperform competitive products on properties such as fastener retention by using a consistent strand quality with a thin thickness (e.g., 0.01-0.015 inches), a resin fraction sufficient to coat the strands in the building material (e.g., <5% by volume), a random strand orientation, a high density of strands of grass in the board (e.g., between 66-100 strands per inch along the board thickness), and/or otherwise achieve increased fastener retention.

Third, variants of the technology can include building materials that are a direct substitute for traditional home construction products and require no alternative installation techniques. In examples, the output product is a drop-in replacement for the materials in use today. The building material can function in the same or similar manner for subfloor, wall sheathing, roofing, and/or other building materials, and installs in the same manner.

Fourth, in variants, the manufacturing system for producing the alternative building material can be modular, which can allow the system to move much quicker and adopt a process of creating material with a much lower cost to entry and a much quicker timeline. In an example, all or portions of the manufacturing system can be set up in situ and/or adjacent to the raw material growing location, which can reduce transport costs, increase overall production speed, and increase manufacturing efficiencies.

Fifth, in variants, the manufacturing process can be a continuous process that is fully electric and does not use the burning of any raw material (e.g., in order to dry the strands prior to pressing).

Sixth, the inventors have discovered that raw materials (e.g., plants) that primarily include long thin fibers (e.g., Arundo Donax, Moso bamboo, green industrial hemp, etc.) are more easily stranded by systems such as the stranders and flakers disclosed herein, and produce durable strands that hold up well over time. Additionally, due to their flexibility and size, such fibrous materials are compatible with machines that form material into irregular shapes (e.g., die-cutting machines, pultrusion machines, etc.), which enables shapes to be generated which could not be generated using conventional materials (e.g., wood shards, wood shreds, wood chips, etc.). For example, thin, fibrous materials can conform to molds more easily.

Seventh, the inventors have discovered that by putting waste material (e.g., manufacturing waste, agricultural waste, etc.) in interior layers of the board; recycled material can be added to the board without significantly compromising desired material properties (e.g., tensile strength, water resistance, etc.). The inventors have additionally discovered that by dynamically layering different concentrations of shreds, binding agent, and waste material and pressing them together (e.g., instead of laminating distinct layers together), interlaminar weaknesses between layers can be minimized.

However, the technology can confer any other suitable benefits.

### 4. System

As shown in FIG. 2A, an alternative building material can include a plurality of strands (106) of a raw material (102) and a binding agent (108). The alternative building material can optionally further include additional additives (109), and/or any other suitable materials.

However, the system can include any other elements.

### 4.1 Raw Material (102).

The raw material (102) can function as the primary component of the alternative building material. The raw material is preferably a plant, but can alternatively be another raw material. In variants, the building material can include a plurality of strands of one or more raw materials.

Preferably, the raw material includes the perennial grass Arundo Donax (e.g., otherwise known as giant cane, elephant grass, carrizo, Arundo, Spanish cane, Colorado river reed, wild cane, giant reed, etc.). Additionally or alternatively, the raw material can include other grasses (e.g., monocots, monocotyledons, producing vascular strands, producing monocotyledonous strands, etc.), any species within the Poaceae family (e.g., members of the Arundinoideae subfamily of true grass, miscanthus, perennial canes, etc.), any reed species, another perennial grass (e.g., bamboo, sugarcane, etc.), wood, any bamboo species (e.g., Moso, etc.), industrial hemp, sunchoke, corn, and/or any other plant.

In a variant, the raw material can be Arundo Donax, and can be harvested between latitude 30°-80° (e.g., between 33.355726° and 37.200347°) and/or between longitude −75°-−118° (e.g., between −76.50236° and −117.599456° ), but can additionally or alternatively be harvested in any other suitable geographic location and/or region. In examples, the raw material can be harvested at a region encompassing one of the latitude longitude coordinate pairs encompassed by the range above (e.g., a region within a 1 mile radius, within a 5 mile radius, within a 15 mile radius, within a 20 mile radius, within a 25 mile radius, within a 50 mile radius, within a 100 mile radius, etc.), a region proximal to one of the latitude longitude coordinate pairs, and/or otherwise located.

In examples, the plant, when harvested, can be hollow, solid, and/or otherwise configured. In examples, the plant can be harvested at a young state, mature state, old state, a green state (e.g., prior to flowering, etc.), a vegetative state, a flowering state, and/or at any other state.

In variants, the raw material can include any part of the plant, including: components from the stalk of a plant (e.g., a plurality of strands cut from the plant stalk), plant stems, plant rhizomes, leaves, roots, meristem, the entirety of a harvested plant, and/or other components of a plant. Optionally, the raw material can exclude an outer layer of the plant (e.g., the epidermis, etc.), a core of the plant (e.g., hurd, a lower density material, etc.), fine, stems, leaves, roots, fluids (e.g., sap), and/or any other component of the plant. Optionally, the raw material can include waste (e.g., stalks, husks, bagasse, stover, etc.) from billet-like crops such as corn and sugarcane, and/or other agricultural waste (e.g., fibrous waste). Optionally the raw material can include manufacturing waste. Manufacturing waste can include waste from the board manufacturing process (e.g., board trimmings, fragmented waste board) and/or other manufacturing processes (e.g., processes for manufacturing boards with other compositions from the mixture; for example, fragments of wood particleboard, etc.). Alternatively, the raw material can exclude waste.

In examples, a cross section of the raw material can be round with a diameter (e.g., a culm diameter) in a range between 0 and 2 inches, or greater than 2 inches. In specific examples, the plant can have a culm diameter: between 0.250 inches to 1.50 inches (e.g., Arundo Donax), greater than 2 inches (e.g., Moso), between 2-5 inches (e.g., bamboo), 0.250 inches or less (e.g., Miscanthus, Industrial hemp, etc.), greater than 1 inch (e.g., sugarcane), less than 0.5 inches (e.g., sunchoke), and/or any other diameter.

In variants, the raw material can have fibers (e.g., in its stalk, stem, leaves, etc.). In examples, the fibers can have a high cellulose content expressed as a percentage of the total biomass of the fiber (e.g., 40%-50%, greater than 50%, greater than 60%, greater then 70%, greater than 80%, etc.), but can alternatively have a low percentage of cellulose by total biomass (e.g., less than 40%, etc.). The fibers can also satisfy a set of target mechanical properties. In an example, the fibers can have an average tensile strength in a range of about 600 to 1200 MPa (e.g., about 600-800 MPa, 800-1000, 1000-1200 MPa, 900 MPa, 800-850 MPa, 810-860 MPa, 820-870 MPa, 830-880 MPa, 840-890 MPa, 850-900 MPa, 860-910 MPa, 870-920 MPa, 880-930 MPa, 890-940 MPa, 900-950 MPa, 910-960 MPa, 920-970 MPa, 930-980 MPa, 940-990 MPa, 950-1000 MPa,), but the fibers can have an average tensile strength less than 800 MPa or greater than 1000 MPa. In another example, the fibers can have an average elastic modulus in a range of about 30-60 GPa (e.g., about 45 GPa, 31-56 GPa, etc.), but can alternatively have an average elastic modulus lower than 30 GPa, higher than 60 GPa, and/or any other suitable elastic modulus.

However, the raw material can include any other elements.

### 4.2 Strands (106) of the Raw Material.

The strands (106) of the raw material (102) can function to provide structure to the alternative building material.

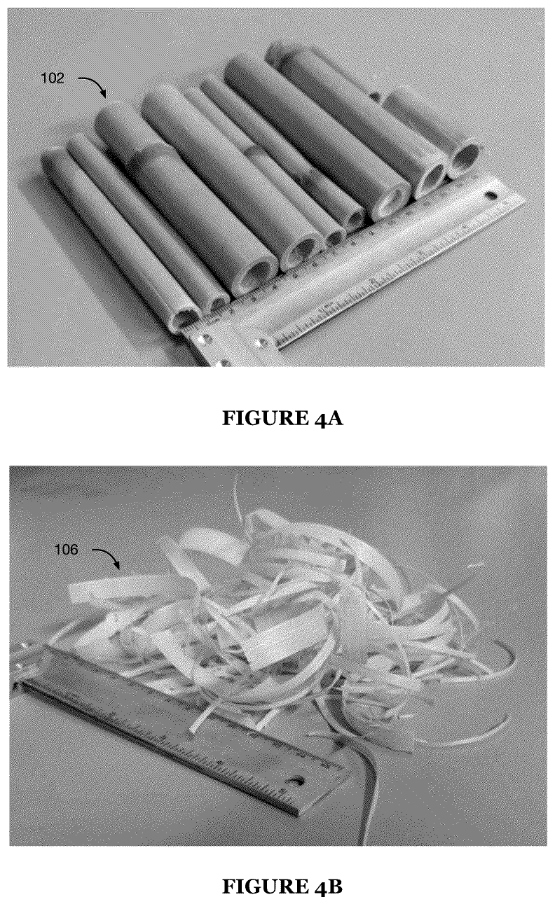

A strand is preferably cut or shaved from the raw material, but the strand can alternatively be torn from or otherwise extracted from the raw material. As shown in FIG. 37, each strand preferably includes a plurality of natural fibers from the plant (e.g., the raw material), wherein the fibers preferably extend along the length of the strand, but can be otherwise oriented. A fiber (e.g., plant fiber) is preferably substantially longer than it is wide, but can have other ratio of dimensions. A fiber preferably includes a combination of polysaccharides (e.g., cellulose, hemicellulose, etc.), but can additionally or alternatively include lignocellulosic material (e.g., polysaccharides, an aromatic, etc.), and/or have any other suitable composition. Each strand is preferably two or more fibers wide, but can have any other suitable width. The natural arrangement of the fibers (e.g., as grown in the plant) is preferably preserved within each strand (e.g., the natural fiber structure is preserved, etc.), but can alternatively be changed. The natural fiber composition of the plant is preferably preserved within each strand (e.g., see example strands in FIG. 4B), but can alternatively be changed (e.g., mechanically, chemically, etc.). However, the building material can be made from particulates (e.g., fines), fibers, shavings (e.g., thin pieces of biomass shorter than a strand or flake), flakes (e.g., thin pieces of biomass shorter than a strand), wafers, chips (e.g., small- to medium-sized pieces of biomass chipped or cut from the raw material; having a thickness similar to the width; etc.), veneer (e.g., a thin, continuous sheet of biomass, with a width and/or length longer than a strand), pulp (e.g., fibers in solution, fibers that have been broken down and/or separated, etc.), leaves, wool (e.g., endodermis, material inside the culm, etc.), and/or other components of and/or extracted from the raw material (e.g., wherein references to “strand” herein can refer to the other raw material form factor or combination thereof). Different raw material form factors (e.g., strands, flakes, wafers, chips, shavings, slivers, wool, etc.) can be defined by different dimensions, or be synonymous. For example, a strand can have a length at least 150 times the least dimension of the strand (e.g., 150 times the thickness, 150 times the width, etc.), while flakes, wafers, chips, and shavings can be shorter than strands (e.g., with lengths that are 100 times the least dimension, 50 times the least dimension, 10 times the least dimension, etc.) and/or have different (e.g., smaller) aspect ratios.

The alternative building material can include a plurality of strands, which can be uniform or non-uniform in size and/or composition.

The strands preferably have a low thickness to length aspect ratio, but the strands can alternatively have a high thickness to length ratio. The strand thickness to length ratio can be of less than or equal to 1:400, more preferably in a range between 1:200 and 1:900, but can additionally or alternatively have an aspect ratio with any range therebetween (e.g., about 1:200-1:400, about 1:300-1:500, about 1:400-1:600, about 1:500-1:700, about 1:600-1:800, about 1:700-1:900), less than 1:200, less than 1:900, in a wider range (e.g., about 1:6-1:1800), less than 1:6, less than 1:10, less than 1:20, less than 1:50, less than 1:100, less than 1:200, less than 1:300, less than 1:400, less than 1:500, less than 1:600, less than 1:700, less than 1:800, less than 1:900, less than 1:1000, less than 1:1100, less than 1:1200, less than 1:1300, less than 1:1400, less than 1:1500, less than 1:1600, less than 1:1700, within an open or closed range bounded by any of the aforementioned values, and/or any other suitable thickness to length ratio.

The strands can have a length that is less than or equal to the length of the harvested plant. In a preferred variant, the strand length is less than or equal to the length of the billets (e.g., the sections cut in S200) or a culm. The strands preferably have a length greater than 3 inches, more preferably between 4-10 inches (e.g., about 4-8 inches, 4-9 inches, 3-5 inches, 4-6 inches, 5-7 inches, 6-8 inches, 7-9 inches, 4 inches, 5 inches, 6 inches, 7 inches, 8 inches, 9 inches, etc.), but can additionally or alternatively have a length less than 20 inches, less than 15 inches, less than 10 inches, less than 9 inches, less than 8 inches, less than 5 inches, less than 3 inches, more than 9 inches, more than 10 inches, more than 18 inches, within an open or closed range bounded by any of the aforementioned values, and/or have any other suitable length.

The strands can have a width that is less than or equal to the outer diameter of the harvested plant. Preferably the strand width is greater than 0.15 inches, more preferably between 0.2-1.2 inches (e.g., about 0.2-0.5 inches, about 0.5 inches, about 0.35-0.6 inches, etc.), but can additionally or alternatively have a width less than 0.2 inches (e.g., 0.15 inches), greater than 1.2 inches, less than 3 inches, between about 1.5-2.5 inches, between 0.1″-1″, and/or have any other suitable width. The strand width is preferably substantially constant along the strand length (e.g., less than 50%, 40%, 30%, 20%, 10%, 5%, or lower variance between opposing ends), but can alternatively be variable along the strand length.

The strands can have a thickness between the minimum fiber thickness of the plant and the maximum culm thickness and/or diameter of the plant. Preferably, the strand thickness is greater than or equal to about 0.01 inches, more preferably between 0.01-0.025 inches, but can additionally or alternatively have a thickness in a range of about 0.001-0.25 inches (e.g., 0.005-0.1 inches), less than 0.005 inches, greater than 0.015 inches, greater than 0.25 inches, and/or any other suitable thickness. The strand thickness is preferably substantially constant along the strand length and/or width (e.g., less than 50%, 40%, 30%, 20%, 10%, 5%, or lower variance between opposing ends), but can alternatively be variable along the strand length.

The raw material (e.g., the strands thereof) preferably has a moisture content in a range between 1% to 25% dry basis (e.g., 7-12% dry basis, 5%-15% dry basis, 10%-12% dry basis, etc.), but can have moisture content below 1%, higher than 25%, and/or any other suitable moisture content. The strands can be dried before strand formation (e.g., wherein the entire harvested plant is dried prior to stranding, wherein a component of the plant is dried prior to stranding, etc.), after stranding into strands, prior to being blended with the binding agent, after being blended with the binding agent, prior to forming, after forming, and/or at any other suitable time. In examples, the raw material (e.g., the strands thereof) has a moisture content in a range between 1% to 50% dry basis prior to drying (e.g., about 10-15% dry basis). After drying, the raw material (e.g., the strands thereof) can have a moisture content in a range between 1% to 25% dry basis (e.g., 7-12% dry basis).

However, the strands (106) of the raw material (102) can be otherwise configured.

### 4.3 Auxiliary Material (107).

The building material can optionally include one or more auxiliary materials (107) (e.g., filler materials, additives, etc.). Auxiliary materials are preferably not raw material (e.g., non-reed material), such as wood waste (e.g., waste wood, such as wood pulp, sawdust, wood chips, wood particles, etc.), manufacturing waste, agricultural waste, grass waste (e.g., recycled grass fiber), other waste materials, rubber, plastic, metals, or additives (e.g., flame retardants, bio retardants, strengthening agents, etc.), but can alternatively be or include raw material (e.g., waste strands, fragments of building material trimmings, chips, particles, dust, pulp, leaves, etc.). The auxiliary material can be homogeneously distributed through the building material, concentrated in a region of the building material (e.g., in the middle, in the core, at the edges, at the exterior, etc.), or otherwise arranged. The auxiliary material can be mixed into the raw material (e.g., into the strands), into the binding agent, into a coating, into an additive, be used as a substrate material, be used in lieu of the raw material, and/or into any other suitable component of the building material. In a first example, the auxiliary material is heterogeneously mixed into the building material. In a second example, the auxiliary material is arranged in an interior layer sandwiched between reed-based outer layers.

However, the auxiliary material can be otherwise configured.

### 4.4 Binding Agent (108).

The binding agent (108) can function to bind (e.g., adhere) the pieces of reduced raw material (e.g., strands) to one another. The binding agent can additionally or alternatively function to prevent water from absorbing into the building material, add material properties to and/or improve material properties of the building material (e.g., nail withdrawal resistance, head pull through strength, fire resistance, pest resistance, etc.), and/or perform other functionalities. Additionally or alternatively, these properties can be entirely or partially conferred by the raw material.

The building material can include one or more binding agents (e.g., binding agents combined as a mixture, binding agents applied to the building material in a serial application, etc.). In variants, the binding agent can be applied to the strands of raw material to coat the surface of each strand prior to forming the final building material. The binding agent can be mixed, sprayed, dipped, soaked, and/or otherwise applied to the raw material. The binding agent can be applied to the raw material: evenly (e.g., along all surfaces), unevenly, along a first broad face, along opposing broad faces, along the sides of the raw material, and/or otherwise applied to the raw material.

The binding agent can include resin, wax, glue, adhesives, and/or any other binding agent.

In a first set of variants, the binding agent can include one or more synthetic resins and/or glues. Examples include: isocyanate resins (e.g., methylene diphenyl diisocyanate (MDI) resins; polymeric methylene diphenyl diisocyanate (PMDI), emulsifiable methylene diphenyl diisocyanate (EMDI), etc.); formaldehyde-based resins (e.g., melamine-urea-formaldehyde (MUF) resin glues, phenol formaldehyde resin glues, urea-formaldehyde resin glues, Melamine Urea Phenol Formaldehyde (MUPF) resins, etc.); phenolic resins; amino resins; ammonia-based resins; and/or any other synthetic resins.

In a second set of variants, the binding agent can include a bio-based resin (e.g., plant-based resin, epoxy, etc.). Bio-based resins can include materials made from base materials including: unsaturated vegetable oils (e.g., soybean oil, linseed oil, canola oil, karanja oil, etc.), saccharides, tannins, cardanols, terpenes, rosins, lignin, carboxylic acid, protein, natural rubber, emulsion polymer isocyanate (EPI), 1C PUR polyurethane, and/or any other base materials. In examples, the base material can be cured with one or more co-reactants (e.g., hardener, curative, etc.). The bio-based resins can also be made from materials that capture carbon (e.g., are net-carbon neutral), are organic, and/or have any other suitable set of properties. Examples of bio-based resins include lignin-based resins, rosin-based resins (e.g., rosin-based hot melt adhesives), amber-based resins, shellac-based resins, gum arabic-based resins, cashew nut shell liquid (CNSL) resins, tannin-based adhesives, furan resins, fungal resins, but bio-based resins can include any other suitable type of bio-based resin.

In a third set of variants, the binding agent can include a combination of resins and/or fillers. In a first example, the binding agent can include a blend of two or more types of bio-based resins. In a second example, the binding agent can include a blend of one or more bio-based resins and one or more synthetic resins. In a third example, the binding agent can include one or more types of resin (e.g., synthetic resin, bio-based resin) blended with one or more fillers. Fillers can include: inorganic fillers, glass fibers, particulates (e.g., of the raw material, other materials, etc.), and/or any other fillers.

However, the binding agent (108) can be otherwise configured.

### 4.5 Additional Additives (109).

The building material can optionally include additional additives (109), which can function to alter and/or enhance properties of the building material. In examples, additives can provide protection against fire damage, moisture damage, insect damage, fungal damage, wear, and/or any other forms of damage; increase the building material strength, flexibility, and/or other material property; and/or provide other benefits. Additives can be added to (e.g., mixed into) the binding agent, the raw material, applied as a coating (e.g., to the raw material, to the formed product, etc.), and/or otherwise applied to any other suitable component of the building material.

Examples of additives can include: wax, paint, a sealing means (e.g., tape, laminate, caulk, foam, spray, putty, mechanical means, paper, etc.), mineral additives, plaster, poison, oils (e.g., cedar oil, citronella oil, etc.), copper chromates, boron based wood preservatives, insecticides, Wolmanit, PEG 400, DSHP, DAHP, HBCD, halogen-based fire-retardant compounds, inorganic salts-based fire retardant compounds (e.g., hydroxides, phosphates, carbonates, sulfates, potassium carbonate, aluminum, magnesium hydroxyl, etc.), boron-based fire retardant compounds (e.g., boric acid, borax, etc.), phosphorous-based fire retardant compounds (e.g., phosphate esters, phosphonates, phosphinates, polyphosphonate, phosphonic acid salts, etc.), nitrogen-based fire retardants (e.g., melamine), phosphorous-nitrogen-based fire retardant compounds, silicon-based compounds (e.g., silicones, silicates, organosilanes, or silsesquioxanes, etc.), nanocomposite fire retardant compound, intumescent coatings (e.g., DC360), phenol-formaldehyde resins, ionic liquids, and/or any other fire retardant, and/or any other insect repellant, and/or any other anti-fungal additive, and/or any other anti-mold additive, and/or any other additive. In further examples, additives can include components (e.g., fines, dust, fibers, particulates, etc.) of the raw material (e.g., Arundo Donax, bamboo, other plants, etc.) and/or other raw materials.

In variants, additives can be blended with the binding agent and/or the strands of raw material (e.g., prior to pressing, prior to forming, etc.). In further variants, can be added to the building material during the finishing stage (e.g., after pressing, during S800, etc.). In a first example, these additives can include coatings, sprays, and/or any other additives that are applied to the exterior of a member. In a second example, these additives can be applied with a pressure treatment to fully permeate the member. Additionally or alternatively, the building material can be processed to confer one or more desired properties (e.g., selectively charred for fire-proofing).

Additives can optionally include coatings. In variants, coating can be applied along the building material: exterior (e.g., along one or more ends, edges, sides, broad faces, etc.), interior (ex. between layers), and/or any other suitable surface. In examples, coatings can include any of the aforementioned additives, resin-impregnated paper, acrylic resins (e.g., acrylic emulsion coating from Akzo-Nobel), Valspar's Black Board Coating, anti-skid coatings, laminates, tapes, permeable fabrics, foil (e.g., a metal foil, aluminum foil, etc.), acrylic latex-based paints, oil-based primer, and/or any other coating.

However, additional additives (109) can be otherwise configured.

### 4.6 Building Material (114) Form Factors.

However, additional additives (109) can be otherwise configured. The building material (114) can include a raw material, a binding agent, and/or optionally include any other additional additives. The building material can have any suitable form. The building material can be a structural member, a non-structural member, and/or any other member. The final form may be produced in multiple form factors such as panels, beams, headers, columns, dowels, billets, siding, flooring, trim, paneling, decking, shingles, aesthetic features, furniture components (e.g., legs, etc.), irregular shapes, and/or any other form factor. Examples of panels that can be formed include: single-layer panels, multi-layer panels (e.g., wherein different layers can have the same or different composition, strand orientation, or otherwise differ), strandboard (e.g., oriented or non-oriented strandboard), chipboard, a glued stack of reed veneer (e.g., plywood analog), particleboard, fiberboard (e.g., MDF, HDF, etc.), and/or other panels.

In a first set of variants, the building material can be a panel (e.g., a structural panel, a non-structural panel, sheathing, etc.). The panel can have two opposing broad planar faces and a set of peripheral edges. The panel can be produced with any desired thickness, width, and/or length. In a specific example, the panel can be a 7/16″×4′×8′ panel.

In examples, the panel thickness can have a thickness between 5/16-1-½ inches (e.g., with a thickness in inches of: 5/16, ⅜, 15/32, ½, 19/32, ⅝, 23/32, ¾, ⅞, 1, 1-⅛, 1-¼, 1-½, etc.). However, panels can be produced with a thickness: less than 5/16 inches (e.g., ¼″, ⅛″, etc.), greater than 1-½ inches (e.g., 1-⅝″, 1-¾″, etc.), and/or any other thickness in a range between 5/16″-1-½″ (e.g., 7/16″).

In examples, the panel can be produced in a nominal size (e.g., as defined by Section 3.1.3.1 of ESR-2586: 4′×8′, 4′×9′, 4′×10′). However, panels can be produced with a width less than or greater than 4 feet. Additionally or alternatively, panels can be produced with a length below 8 feet, above 10 feet, or at any other length between 8 to 10 feet.

In a second set of variants, the building material can be a beam and/or a header. Examples include a: 1×2, 2×4, 2×6, 2×8, 2×10, 2×12, 4×4, 1-1/4×6, and/or any other suitable beam cross section of any desired length. Example lengths can fall in a range of 6 inches to 30 feet (e.g., 1′, 2′, 4′, 6′, 8′, 10′, 12′, 16′, 18′, 20′, etc.). However, the beam produced can be shorter than 6 inches, or longer than 30 feet. The building material (e.g., the beam, the header) can have any suitable cross sectional shape (e.g., T-beams, C-beams, I-beams, L-beam rectangular beams, arcuate beams, etc.). In this variant, the building material is preferably straight in the longitudinal direction but can alternatively be curved. In a specific example, the building material can include a beam with oriented strands (e.g., substantially oriented along the longitudinal axis), wherein the beam can have a modulus of elasticity of 1.3 MSI or better. The beam can include a single layer or multiple layers (e.g., laminated layers).

In a third set of variants, the building material can be a rod, dowel (e.g., circular dowel, square dowel, etc.), or any other member in the form of a cylindrical prism and/or rectangular prism. The diameter and/or thickness can take on a value between 0.05 inches and 1 foot, and can take on any length (e.g., lengths discussed in beam variant).

In a fourth set of variants, the building material can have an irregular 3D shape. Examples of irregular building material shapes include the shapes of a couch, chair, table, components thereof (e.g., legs, back, seat pan, tabletop, etc.), and/or any other suitable shape. In these variants, the building material can be: molded (e.g., injection molding, blow molding, rotational molding, compression molding, etc.), extruded, pultruded, thermoformed, cast, and/or otherwise formed.

The building material can additionally or alternatively include one or more features. The features can function to: engage with another panel (e.g., a complimentary feature on another panel), confer material properties (e.g., strength, water resistance, etc.), and/or confer other benefits. The features can be arranged along: the building material broad face (e.g., upper face, lower face, both faces, etc.), the building material edge or side (e.g., vertical edge, vertical side), and/or along any other suitable portion of the building material. The features can extend: parallel an edge, parallel an axis (e.g., stranding axis, longitudinal axis, lateral axis, etc.), at an angle to the edge or axis, and/or in any other suitable direction or orientation. Examples of features that can be included include: a tongue, a groove (e.g., complimentary to the tongue), butt joints, dado joints, mortise and tenon, dovetail joint, miter joint, biscuit joiner, lap joint, half lap, rabbets (e.g., rabbet joints), divots, through-holes, and/or any other suitable feature. The building material can have a square edge, beveled edge, ogee edge, cope edge, and/or any other suitable edge profile. A building material can include no additional features, a single additional feature, a pair of additional features (e.g., complimentary halves of a joint), multiple additional features (e.g., multiple instances of the same feature, a combination of different features), and/or any other suitable set of features. In examples, building features (and/or edges and/or corners of the building material) can have a corner radius of 0″, 0.05″, 0.1″, 0.25″, 0.5″, 1″ 2″, 3″, within an open or closed range bounded by the aforementioned values, and/or any other suitable corner radius or range of corner radii. In such examples, each corner radius is preferably on an outer corner but can alternatively be on inner corners, saddle corner, scotia corner, convex corner, concave corner, and/or a corner of any other suitable shape. In examples, the irregular building material shapes can include convex features and/or concave features (e.g., convex corners and/or concave corners, etc.).

However, the building material (114) can be otherwise configured.

### 4.7 Building Material (114) Properties.

The building material (114) can be made from a raw material, a binding agent, and/or optionally any other additional additives.

In a first variant, the building material can include one or more raw materials, binding agent, and optionally additives (e.g., fillers, flame retardants, etc.).

In a second variant, the building material can consist essentially of (e.g., only include) a raw material and a binding agent. In a specific example, the building material consists essentially of monocotyledonous strands (e.g., of Arundo Donax or another raw material) bound together by a binding agent, wherein the mat has a transverse cross-sectional strand density of at least 40 strands per inch. However, the building material can include other materials and/or other compositions.

However, the building material can be otherwise formulated.

The raw material is preferably from a single plant species and/or accession, but can additionally or alternatively be from multiple plant species, multiple plant genera, multiple plant families, and/or include any other suitable combination of plants. The composition of different plants can be selected based on the desired physical properties of the resultant building material, be selected based on the overall carbon footprint, and/or otherwise selected.

The building material (114) is preferably made from strands of the raw material(s), but other forms of the raw material(s) (e.g., fibers, chips, etc.) can alternatively and/or additionally be used.

Preferably, the strands are primarily strands from the plant stem (e.g., culm). Preferably, particulates and/or other portions of the plant (e.g., leaves, fines, dust, etc.) are removed (e.g., sifted out) from the strands. Alternatively, the raw material can include a small percentage of particulates and/or other portions of the plant (ex. less than 50%, 40%, 30%, 20%, 10%, 5%, 3%, 1%, 0.5%, 0.1% by weight or volume), or include larger percentages of other raw material form factors (e.g., more than 50%).

In variants, the building material can have one or more layers (e.g., one layer, two layers, three layers, four layers, etc.). Each layer is preferably independently manufactured (e.g., independently formed; independently manufactured using the method disclosed below, etc.) and subsequently assembled together, but can alternatively be manufactured together (e.g., as a uniform or non-uniform unitary product).

Each layer can include a binding agent and a plurality of strands of raw material. Additionally or alternatively, one or more of the layers can further include additives, fillers, other components of the raw material, and/or any other component. Within each layer, the strands can be substantially extended, substantially compressed (e.g., coiled, bunched, etc.), and/or some combination thereof. Different layers can have the same or different formulations (e.g., include or exclude additives, include different mixtures of raw materials, etc.), the same or different physical characteristics (e.g., strand orientation, strand density, etc.), and/or be otherwise similar or dissimilar. Different building material layers can have the same or different compositions (e.g., the same or different reed:binding agent:auxiliary material ratios), the same or different material orientations (e.g., the same or different reed strand alignment), and/or otherwise differ. The building material composition can be substantially constant throughout, or vary throughout the length, width, and/or thickness of the building material.

The building material (e.g., each building material layer) can have a strand orientation, density, strand density, raw material fraction, binding agent fraction (e.g., resin fraction), filler fraction, and/or any other physical characteristic. These physical characteristics can be adjusted to adjust the performance of the building material.

The building material can be substantially homogeneous throughout, or have varying characteristics along a building material axis (e.g., vary along the thickness, length, or width) or region. The regions can be formed from distinct layers (e.g., distinct boards adhered together), continuous layers (e.g., formed as a unitary board, formed by depositing layers of different compositions then pressing the different layers together contemporaneously to form the board, non-discrete layers, etc.), or otherwise formed. Continuous layers can include discrete or smooth transitions between different regions (e.g., with different compositions). For example, the building material can have an outer region composition that transitions to an inner region composition (e.g., along the middle of the building material), wherein the transition can be gradual, linear, stepwise, logarithmic, exponential, or otherwise defined. The strand orientation can define the strength axes of the building material and/or confer other physical properties. Within each layer, the plurality of strands can share a common orientation scheme (e.g., random, unaligned, aligned, substantially aligned along a longitudinal axis, substantially aligned along a lateral axis, substantially aligned along a vertical axis, etc.) and/or have varying orientation schemes. Strands can be substantially aligned when at least: 30%, 40%, 50%, 60%, 70%, 80%, 90%, and/or any other proportion of the strands are aligned within a threshold angle of the axis (e.g., within 5°, 10°, 15°, 20°, 25°, 30°, 35°, 40°, 45°, etc. of a reference axis). For example, the stands can be substantially aligned with an axis when 50% or more of the strands are aligned within 30° of the axis. Preferably, the raw material (e.g., strands) within the building material are unwoven, but can alternatively be woven.

In a first variant, the strands within a layer can be randomly oriented with respect to all axes, faces, and/or other reference geometries of the building material. In a first example, a layer can include anisotropically or randomly-aligned strands (e.g., relative to a longitudinal and/or lateral axis).

In a second variant, the strands within a layer can be substantially oriented with respect to one or more axes of the building material (e.g., lateral axis, longitudinal axis, vertical axis, strength a diagonal axis, etc.), one or more planes of the building material, and/or other reference geometries of the material (e.g., deviate less than 90°, less than 60°, less than 45°, etc. from each other or the reference geometry; have a population-level average or median alignment substantially approximating the reference geometry; etc.).

In a first example, all strands within a layer are substantially aligned in a common direction. The direction can be along any of the axes of the building material (e.g., a strength axis, parallel to a planar face, etc.), or any orientation.

In a second example, all strands within a layer are substantially oriented relative to one axis of the building material, and not consistently oriented relative to a second axis of the building material. The strands can be randomly oriented, or otherwise oriented.

In a third example, all strands within a layer are substantially oriented such that each strand lies flat relative to a face of the building material, but is not consistently oriented relative to the other strands.

In a third variant, the strands within a layer can be woven.

In a fourth variant, the building material includes a combination of a pulp and/or particulates and a binding agent. In this example, a composite mixture of the binding agent and the pulp and/or particulates are formed and cured.

The density of the building material can define the water resistance, the bend strength, the shear strength, and/or confer other physical properties. The density (e.g., a baseline density) of the building material can be in a range of 600-700 kg/m\hat{ }3 (e.g., 600-610 kg/m\hat{ }3, 605-615 kg/m\hat{ }3, 610-630 kg/m\hat{ }3, 620-640 kg/m\hat{ }3, 630-650 kg/m\hat{ }3, 640-660 kg/m\hat{ }3, 650-670 kg/m\hat{ }3, 660-680 kg/m\hat{ }3, 675-685 kg/m\hat{ }3, 670-690 kg/m\hat{ }3, etc.). However, in further variants the density can be less than 600 kg/m\hat{ }3, greater than 700 kg/m\hat{ }3, about 680 kg/m\hat{ }3, and/or fall within any other suitable range. The building material density can be selected based on the building material form factor, the application, and/or otherwise selected. In examples, the building material density can be controlled by: the resin fraction, the strand density, the raw material properties, the rate and/or force of the press used to form the building material, and/or other inputs. In variants, the building material can be defined by material properties and/or other qualities that are: anisotropic, isotropic, symmetric (e.g., transversely isotropic), and/or otherwise defined relative to the building material.

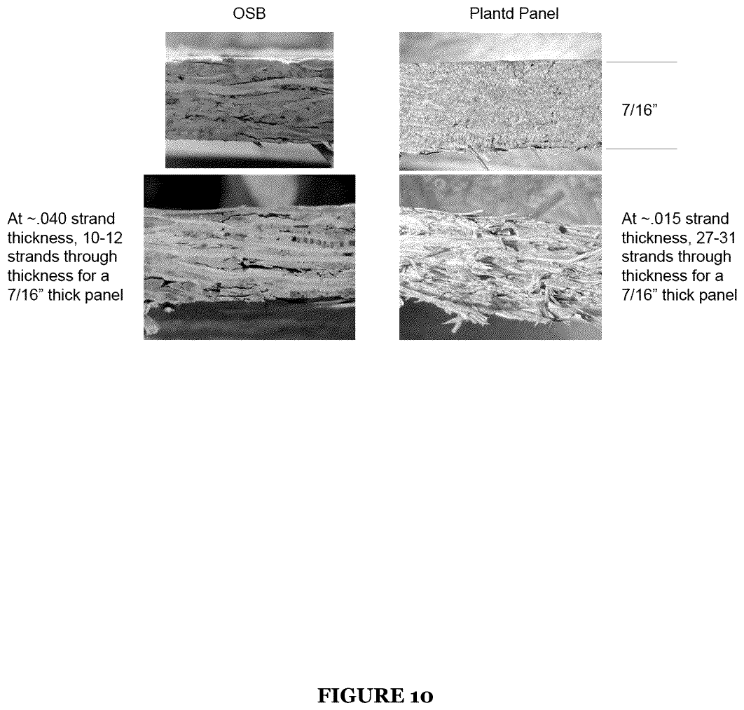

The building material can have a strand density (e.g., raw material density). The strand density is preferably measured along a cross section (e.g., along the building material thickness or transverse plane, transverse cross-sectional strand density, etc.) of the building material (e.g., see FIG. 10), but can alternatively be measured along a building material longitudinal cross section or lateral cross section. In variants, the strand density can be in a range between about 40-140 strands per inch (e.g., in a range between about 40-60 strands per inch, 30-70 strands per inch, 50-70 strands per inch, 60-80 strands per inch, 70-90 strands per inch, 80-100 strands per inch, 90-110 strands per inch, 100-120 strands per inch, 110-130 strands per inch, 120-140 strands per inch, at least 40 strands per inch, at least 60 strands per inch, etc.). However, the building material can be produced with a strand density: less than 40 strands per inch, at least 50 strands per inch, at least 40 strands per inch, at least 30 strands per inch, at least 20 strands per inch, greater than 140 strands per inch, and/or any other strand density. In a specific example, for a 7/16″ thick panel with a strand density in a range of about 66-100 strands per inch, the panel has about 27-31 strands through its thickness. By comparison, standard OSB at a strand thickness of about 0.040 inches would have 10-12 strands through its thickness for a 7/16″ thick panel.

The building material can have a raw material fraction. The raw material fraction is preferably a fraction of overall raw material (e.g., total fraction of material derived from reed; independent of the raw material form factor), but can additionally or alternatively be the fraction of raw material: strands (e.g., a strand fraction), chips (e.g., strand fraction), particles (e.g., particle fraction), fraction of another raw material form factor, and/or be otherwise defined. The building material is preferably mostly raw material (e.g., over 50%, over 75%, etc.), but can alternatively be less than 50% raw material. In examples, the building material overall percentage of raw material by weight (e.g., raw material fraction) can be higher than: 50%, 70%, 90%, 92%, 93%, 94%, 95%, 96%, 97%, 98%, 99%, 99.5%; be 100%; be within any open or closed range bounded by the aforementioned percentages; be lower than: 100%, 99%, 95%, 90%, 80%, 70%, 60%, 50%, and/or another percentage by weight; and/or any other suitable percentage of raw material by weight.

The raw material can be evenly distributed through the building material (or layer thereof), unevenly distributed (e.g., heterogeneously distributed), concentrated in certain regions (e.g., outer regions, inner regions, etc.), and/or otherwise distributed.

In examples, the raw material percentage (e.g., percentage of strands by weight) can change through regions of the building material (e.g., through the thickness, along the length, along the width, etc.). In examples, the outer region percentage of strands by weight can be 50%, 70%, 90%, 92%, 94%, 96%, 98%, 99%, 99.5%, 100%, within any open or closed range bounded by the aforementioned percentages, and/or any other suitable percentage of raw material by weight or range of percentages of raw material by weight. In examples, the transitional region percentage of strands by weight can be 40%, 50%, 60%, 70%, 80%, 90%, within any open or closed range bounded by the aforementioned percentages, and/or any other suitable percentage of strands by weight or range of percentages of strands by weight. In such examples, the inner region percentage of strands by weight can be 0%, 10%, 30%, 50%, 70%, 90%, 95%, 98%, within any open or closed range bounded by the aforementioned percentages, and/or any other suitable percentage of strands by weight or range of percentages of strands by weight.

In examples, the building material can include a percentage of binding agent (e.g., overall percentage, percentage within a given region, etc.) in a range between 1-10%. However, the building material can include a percentage of binding agent: less than 1%, less than 5%, less than 7%, less than 10%, greater than 10%, in any other suitable range (e.g., 1-2%, 2-3%, 3-4%, 4-5%, 5-6%, 6-7%, 7-8%, 8-9%, 3-6%, 1-5%, 5-10%), greater than 50%, and/or any other percentage of binding agent. The percentage of binding agent can be defined by mass, by volume, by mol, and/or otherwise defined. However, the building material can have any suitable ratio of binding agent and strands of raw material. In variants, the binding agent can be distributed throughout the building material: uniformly, such that the binding agent substantially coats all of the raw material (e.g., all of the strands), such that the binding agent substantially saturates all of the raw material, such that the binding agent substantially encompasses all of the raw material, and/or otherwise distributed.

In examples, the percentage of binding agent by weight can change through regions of the building material. In such examples, the percentage of binding agent by weight of a region (e.g., an outer region, a transitional region, an inner region, etc.) can be 0%, 0.5%, 1%, 2%, 3%, 4%, 5%, 6%, 7%, 8%, 9% 10%, 15%, 20%, 30%, 50%, within any open or closed range bounded by the aforementioned percentages, and/or any other suitable percentage of binding agent by weight or range of percentages of binding agent by weight.

The building material and/or regions thereof can optionally include one or more auxiliary materials (e.g., filler materials, additives, etc.).

In examples, the overall percentage of auxiliary material by weight (e.g., overall percentage of auxiliary materials, overall percentage of a given auxiliary material, etc.) can be: 0%; 0.5%, 1%, 2%, 3%, 5%, 10%, 20%, 30%, 40%, 50% 60%, 70%, 80%, 90%, 95%, 99%, 100%, within any open or closed range bounded by the aforementioned percentages; more than 1%, 5%, 10%, 20%, 30%, 40%, 50% 60%, 70%, or any other percentage; and/or any other suitable percentage by weight.

In examples, the percentage of auxiliary material by weight in the building material can change through a region of the board. In such examples, an outer region percentage of auxiliary material by weight can be 0%, 1%, 2%, 5%, 10%, 20%, 30%, 40%, 50% within any open or closed range bounded by the aforementioned percentages, and/or any other suitable percentage of auxiliary material by weight or range of percentages of auxiliary material by weight. In such examples, a transitional region percentage of auxiliary material by weight can be 0%, 5%, 10%, 30%, 50%, within any open or closed range bounded by the aforementioned percentages, and/or any other suitable percentage of auxiliary material by weight or range of percentages of auxiliary material by weight. In such examples, an inner region percentage of auxiliary material by weight can be 20%, 30%, 40%, 60%, 80%, 90%, 95%, 99%, 100%, within any open or closed range bounded by the aforementioned percentages, and/or any other suitable percentage of auxiliary material by weight or range of percentages of auxiliary material by weight.

The building material can optionally include other material (e.g., in addition to raw material, binding agent, and auxiliary material), but can alternatively exclude other material, exclude auxiliary material (e.g., only include raw material and binding agent), and/or have any other suitable composition (e.g., formulation).

In variants, the building material can be configured for use in construction, and required to meet one or more of a set of design criteria and/or have one or more of a set of performance parameter values. Values for a sample of an example of the building material are shown in TABLE 0. However, the building material can have parameter values between 80%-400% of the values shown in Table 0 (e.g., 80%-400%, up to 400%, up to 300%, up to 200%, up to 120%, etc.); parameter values greater than the values shown in TABLE 0 (e.g., for subscale samples; samples with different dimensions, etc.); parameter values lower than the values shown in TABLE 0; parameter values lower than 80% of the values shown in TABLE 0; parameter values greater than 400% of the values shown in TABLE 0; and/or any other suitable values. In a specific example, a 7/16″×4′×8′ structural panel (e.g., a panel with randomly oriented Arundo Donax strands, bound by less than 10% by weight of aerosolized binder) can have the board requirement specifications as indicated in TABLE 0. However, the building material can be configured to take on other form factors and meet the board requirement specifications as indicated in TABLE 0, and/or other board performance specifications (e.g., within 5% of the respective parameter value, within 10% of the respective parameter value, within 20% of the respective parameter value, etc.).

TABLE O
Building Material Parameter Values

| Criteria | Value | Direction | Condition | Test |
|---|---|---|---|---|
| Flexural strength [lbf- | 2,000 | Primary | bending | ASTM |
| in/ft] | | Axis | | D3043 |
| Flexural strength [lbf- | 2,100 | Secondary | bending | ASTM |
| in/ft] | | Axis | | D3043 |
| Flexural stiffness | 69,000 | Primary | bending | ASTM |
| [lbin\hat{ }2/ft] | | Axis | | D3043 |
| Flexural stiffness | 71,100 | Secondary | bending | ASTM |
| [lbin\hat{ }2/ft] | | Axis | | D3043 |
| Bending strength [psi] | 4,750 | Primary | bending | ASTM |
| | | Axis | | D3043 |
| Bending strength [psi] | 4,450 | Secondary | bending | ASTM |
| | | Axis | | D3043 |
| Flexural modulus [psi] | 710,000 | Primary | bending | ASTM |
| | | Axis | | D3043 |
| Flexural modulus [psi] | 650,000 | Secondary | bending | ASTM |
| | | Axis | | D3043 |
| Axial Tension [lbf/ft] | 14,500 | Primary | tension | ASTM |
| | | Axis | | D1037 |
| Axial Tension [lbf/ft] | 15,800 | Secondary | tension | ASTM |
| | | Axis | | D1037 |
| Tensile strength [psi] | 2,650 | Primary | tension | ASTM |
| | | Axis | | D1037 |
| Tensile strength [psi] | 2,800 | Secondary | tension | ASTM |
| | | Axis | | D1037 |
| Modulus of Elasticity | 770,000 | Primary | tension | ASTM |
| [psi] | | Axis | | D1037 |
| Modulus of Elasticity | 820,000 | Secondary | tension | ASTM |
| [psi] | | Axis | | D1037 |
| Dowel Bearing Strength | 7,970 | Primary | bearing | ASTM |
| [psi] | | Axis | | D5764 |
| Dowel Bearing Strength | 8,530 | Secondary | bearing | ASTM |
| [psi] | | Axis | | D5764 |
| Nail head withdrawal | 117 | N/A | withdrawal | ASTM |
| [lbf/in] | | | | D1037 |
| Nail head pull through | 434 | N/A | pull through | ASTM |
| [lbf] | | | | D1037 |

In variants, the building material can have a bending strength along a primary axis between 3,500 psi-6,000 psi (e.g., 4,750 psi), but can additionally or alternatively have a bending strength along a primary axis between 2,175 psi-7,125 psi, higher than 6,000 psi, lower than 3,500 psi, up to 19,000 psi (e.g., up to 14,250 psi, up to 9,500 psi, etc.), and/or any other suitable bending strength. In examples, the building material can have a bending strength along a secondary axis between 3,300 psi-5,600psi (e.g., 4,450 psi), but can additionally or alternatively have a bending strength along a secondary axis between 2,225 psi-6,675 psi, lower than 3,300 psi, higher than 5,600 psi, up to 17,800 psi, and/or any other suitable bending strength.

In variants, the building material can have a flexural stiffness in a primary axis between 51750 lb-in\hat{ }2/ft to 86250 lb-in\hat{ }2/ft (e.g., 69000 lb-in\hat{ }2/ft), but can additionally or alternatively have a flexural stiffness in a primary axis: between 34500 lb-in\hat{ }2/ft to 103500 lb-in\hat{ }2/ft, of at least 51750 lb-in\hat{ }2/ft, of at least 68000 lb-in\hat{ }2/ft, less than 51750 lb-in\hat{ }2/ft, greater than 86250 lb-in\hat{ }2/ft, greater than 55200 lb-in\hat{ }2/ft, up to 276000 lb-in\hat{ }2/ft, and/or any other suitable flexural stiffness in a primary axis. In examples, the building material can have a flexural stiffness in a secondary axis between 53320 lb-in\hat{ }2/ft to 88880 lb-in\hat{ }2/ft (e.g., 71100 lb-in\hat{ }2/ft), but can additionally or alternatively have a flexural stiffness in a secondary axis: between 35550 lb-in\hat{ }2/ft to 106650 lb-in\hat{ }2/ft, of at least 53320 lb-in\hat{ }2/ft, of at least 70000 lb-in\hat{ }2/ft, less than 53320 lb-in\hat{ }2/ft, greater than 88880 lb-in\hat{ }2/ft, greater than 56800 lb-in\hat{ }2/ft, up to 284400 lb-in\hat{ }2/ft, and/or any other suitable flexural stiffness in a secondary axis.

In variants, the building material can have an ultimate tensile strength (e.g., tensile strength) along a primary axis between 2,000-3,500 psi (e.g., 2,650 psi), but can additionally or alternatively have an ultimate tensile strength: between 2,000 psi-5,000 psi, of at least 2,650 psi, of at least 3,000 psi, less than 2,000 psi, greater than 3,500 psi, up to 10,600 psi (e.g., up to 9,000 psi, 10,000 psi, etc.), and/or any other suitable ultimate tensile strength. In examples, the building material can have an ultimate tensile strength along a secondary axis between 2,200 psi-3,700 psi (e.g., 2,800 psi), but can additionally or alternatively have an ultimate tensile strength: between 2,200 psi-5,200 psi, of at least 3,000 psi, of at least 3,200 psi, less than 2,200 psi, greater than 3,700 psi, of up to 11,200 psi (e.g., up to 10,000 psi, 11,000 psi, etc.), and/or any other suitable ultimate tensile strength. In examples, the building material can have a flexural modulus in a primary axis between 532500 psi to 887500 psi (e.g., 710000 psi), but can additionally or alternatively have a flexural modulus in a primary axis: between 355000 psi to 1065000 psi, of at least 532500 psi, of at least 702000 psi, less than 532500 psi, greater than 887500 psi, greater than 568000 psi, up to 2840000 psi, and/or any other suitable flexural modulus in a primary axis. In examples, the building material can have a flexural modulus in a secondary axis between 487500 psi to 812500 psi (e.g., 650000 psi), but can additionally or alternatively have a flexural modulus in a secondary axis: between 325000 psi to 975000 psi, of at least 487500 psi, of at least 643500 psi, less than 487500 psi, greater than 812500 psi, greater than 520000 psi, up to 2600000 psi, and/or any other suitable flexural modulus in a secondary axis.

In variants, the building material can have an axial tension in a primary axis between 10870 lbf/ft to 18130 lbf/ft (e.g., 14500 lbf/ft), but can additionally or alternatively have a axial tension in a primary axis: between 7250 lbf/ft to 21750 lbf/ft, of at least 10870 lbf/ft, of at least 14300 lbf/ft, less than 10870 lbf/ft, greater than 18130 lbf/ft, greater than 11600 lbf/ft, up to 58000 lbf/ft, and/or any other suitable axial tension in a primary axis. In examples, the building material can have an axial tension in a secondary axis between 11850 lbf/ft to 19750 lbf/ft (e.g., 15800 lbf/ft), but can additionally or alternatively have a axial tension in a secondary axis: between 7900 lbf/ft to 23700 lbf/ft, of at least 11850 lbf/ft, of at least 15600 lbf/ft, less than 11850 lbf/ft, greater than 19750 lbf/ft, greater than 12600 lbf/ft, up to 63200 lbf/ft, and/or any other suitable axial tension in a secondary axis.

In variants, the building material can have a modulus of elasticity in a primary axis between 577500 psi to 962500 psi (e.g., 770000 psi), but can additionally or alternatively have a modulus of elasticity in a primary axis: between 385000 psi to 1155000 psi, of at least 577500 psi, of at least 762000 psi, less than 577500 psi, greater than 962500 psi, greater than 616000 psi, greater than 2000000 psi, up to 3080000 psi, and/or any other suitable modulus of elasticity in a primary axis. In examples, the building material can have a modulus of elasticity in a secondary axis between 615000 psi to 1025000 psi (e.g., 820000 psi), but can additionally or alternatively have a modulus of elasticity in a secondary axis: between 410000 psi to 1230000 psi, of at least 615000 psi, of at least 811000 psi, less than 615000 psi, greater than 1025000 psi, greater than 656000 psi, up to 3280000 psi, and/or any other suitable modulus of elasticity in a secondary axis.

In variants, the building material can have a dowel bearing strength in a primary axis between 5970 psi to 9970 psi (e.g., 7970 psi), but can additionally or alternatively have a dowel bearing strength in a primary axis: between 3985 psi to 11955 psi, of at least 5970 psi, of at least 7800 psi, less than 5970 psi, greater than 9970 psi, greater than 6300 psi, up to 31900 psi, and/or any other suitable dowel bearing strength in a primary axis. In examples, the building material can have a dowel bearing strength in a secondary axis between 6390 psi to 10670 psi (e.g., 8530 psi), but can additionally or alternatively have a dowel bearing strength in a secondary axis: between 4265 psi to 12795 psi, of at least 6390 psi, of at least 8400 psi, less than 6390 psi, greater than 10670 psi, greater than 6800 psi, up to 34200 psi, and/or any other suitable dowel bearing strength in a secondary axis.

In variants, the building material can have a nail head withdrawal force between 80 lbf/in to 150 lbf/in (e.g., 117 lbf/in), but can additionally or alternatively have a nail head withdrawal force: between 58 lbf/in to 176 lbf/in, of at least 80 lbf/in, of at least 100 lbf/in, less than 80 lbf/in, greater than 150 lbf/in, greater than 90 lbf/in, up to 500 lbf/in, and/or any other suitable nail head withdrawal force.

In variants, the building material can have a nail head pull through force between 320 lbf to 550 lbf (e.g., 434 lbf), but can additionally or alternatively have a nail head pull through force: between 217 lbf to 651 lbf, of at least 320 lbf, of at least 400 lbf, less than 320 lbf, greater than 550 lbf, greater than 300 lbf, up to 1800 lbf, and/or any other suitable nail head pull through force.

In variants, the building material can have a bending stiffness along a primary axis between 48,000 lb-in2/ft-72,000 lb-in2/ft, but can additionally or alternatively have a bending stiffness of: at least 60,000 lb-in2/ft, at least 50,000 lb-in2/ft, lower than 48,000 lb-in2/ft, greater than 72,000 lb-in2/ft, and/or any other suitable bending stiffness along a primary axis. In examples, the building material can have a bending stiffness along a secondary axis between 8,800 lb-in2/ft-13,200 lb-in2/ft, but can additionally or alternatively have a bending stiffness of at least 11,000 lb-in2/ft, lower than 8,800 lb-in2/ft, greater than 13,200 lb-in2/ft, and/or any other suitable bending stiffness along a secondary axis.

In variants, the building material can have an ultimate load for lateral nail holding between 175 lbf-335 lbf, but can additionally or alternatively have an ultimate load for lateral nail holding of at least 175 lbf, at least 255 lbf, lower than 175 lbf, at least 335 lbf, and/or any other suitable ultimate load for lateral nail holding.

In variants, the building material can optionally be classified as combustible, non-combustible, and/or otherwise classified. In such examples, combustibility can be defined by any suitable standard (e.g., including ASTM E136-24c, Standard Test Method for Assessing Combustibility of Materials Using a Vertical Tube Furnace at 750° C., and/or any other suitable standards and/or methods).

In variants, the building material can have flame spread rating of 0, 10, 25, 26, 50, 75, 76, 100, 200, 201, 300, 400, 500, 1000, within any open or closed range bounded by the aforementioned values, and/or any other suitable flame spread rating. In a first specific example, the building material has a flame spread rating between 0 and 25 (e.g., “class A”). In a second specific example, this building material has a flame spread rating between 26 and 75 (e.g., “class B”).

In an example of this variant, the building material consists essentially of strands and binding agent and maintains a “class A” rating. In this example, the building material can include no additives (e.g., flame retardants, etc.), essentially no additives, and/or any other suitable amount of additives. In variants with additives, the building material can include, by weight, 0.01% additives, 0.1% additives, 0.5% additives, 1% additives, 2% additives, 3% additives, additives within an open or closed range bounded by the aforementioned values, etc., and/or any other suitable percentage by weight of additives. In this example, the strands can make up 50%, 75%, 90%, 93%, 95%, 97%, 98%, 99%, 99.5%, 99.9%, 100%, any percentage of the building material by weight within an open or closed range bounded by the aforementioned values, and/or can make up any other suitable percentage of the building material by weight. In this example, the binding agent can make up the remainder of the weight of the building material, a subset of the remainder of the building material, and/or none of the remainder of the weight of the building material. However, in other examples, the building material can alternatively have any of the aforementioned compositions while maintaining a “class B” rating.

In examples, flame spread characteristics observed on the subscale can translate and/or not translate in any suitable way to a larger scale. In such examples, flame spread characteristics at the larger scale can be measured using any suitable standard (e.g., including using a 20 foot long Steiner tunnel specimen, ASTM E84-24, Standard Test Method for Surface Burning Characteristics of Building Materials, and/or any other suitable standards and/or methods).

However, the building material (114) can be otherwise configured.

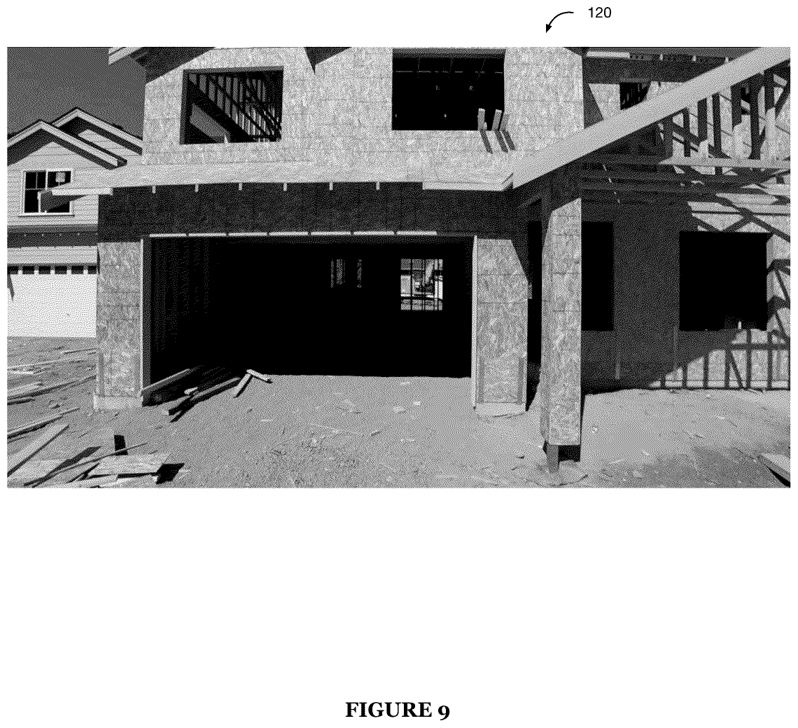

The system can further include a variety of built structures (120) which can be built building material (114). Examples of built structures can include: roofs, decks (e.g., decking), porches, buildings (e.g., houses, apartments, skyscrapers, office buildings, retail buildings, example shown in FIG. 9, etc.), and/or any other suitable built structure manufactured using the building material. In examples, the building material (114) used to build a built structure (120) can be: roofing materials (e.g., roof decking, shingles, shakes, etc.), paneling, sheathing, plywood, beams, braces, joists, rafters, studs, struts, and/or other products. The building material (114) can be used in lieu of traditionally wood products, and/or any other traditional material (e.g., in lieu of concrete, metal, etc.). In a specific example, the system can include a building manufactured from a building material comprising a nonwoven mat of non-oriented monocotyledonous strands bound together by a binding agent.

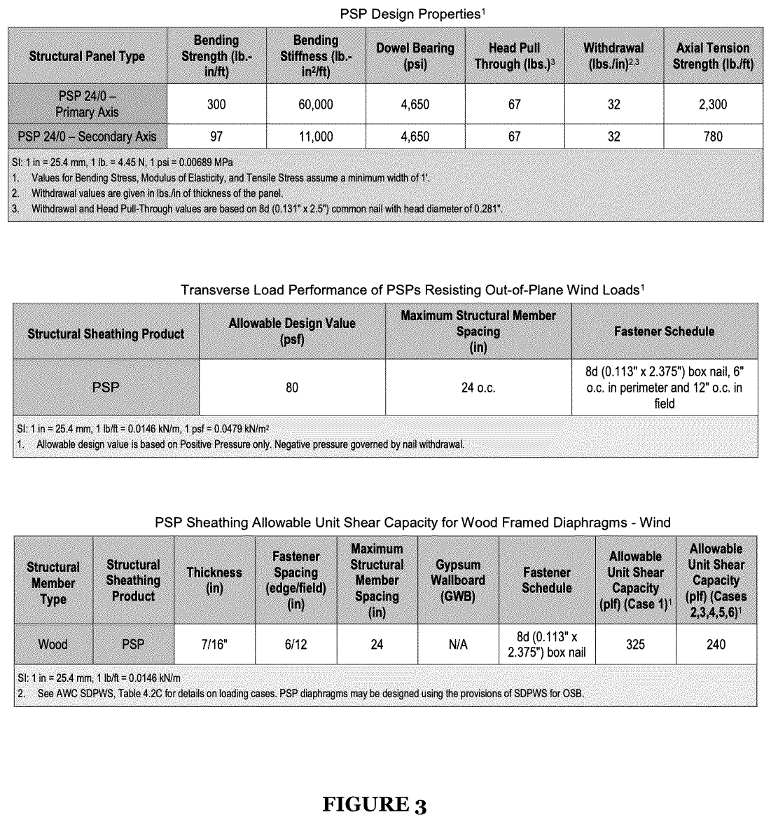

In further examples, the building material can be additionally or alternatively constructed to meet the design values as indicated in TABLE A (e.g., the structural wind load requirements of the Florida Building Code (FBC), see ASTM E330 for details of loading cases, etc.) and TABLE B (e.g., see AWC SDPWS, Table 4.2C for details on loading cases). In a specific example, the building material can be a Planted Structural Panel (PSP), which can be manufactured to meet the design values as indicated in TABLES A and B (e.g., see FIG. 3).

TABLE A
Transverse Load Performance of PSPs
Resisting Out-of-Plane Wind Loads

| | | Maximum | |
|---|---|---|---|
| Structural | Allowable | Structural | |
| Sheathing | Design | Member | |
| Product | Value (psf) | Spacing (in) | Fastener Schedule |
| PSP | 80 | 24 o.c. | 8d (0.113″ x 2.375″) box |
| | | | nail, 6″o.c. in perimeter and |
| | | | 12″ o.c. in field |

TABLE B
PSP Sheathing Allowable Unit Shear Capacity for Wood Framed Diaphragms-Wind

| | | | Maximum | | | Allowable |
|---|---|---|---|---|---|---|
| | | Fastener | structural | | Allowable | Unit Shear |
| Structural | | Spacing | member | | Unit Shear | Capacity (plf) |
| Sheathing | Thickness | (edge/field) | spacing | Fastener | Capacity (plf) | (Cases 2, 3, |
| Product | (in) | (in) | (in) | Schedule | (Case 1) | 4, 5, 6) |
| PSP | 7/16″ | 6/12 | 24 | 8 d | 325 | 240 |
| | | | | (0.113″ × | | |
| | | | | 2.375″) | | |
| | | | | box nail | | |

However, a built structure (120) built building material can be otherwise configured.

### 5. Method

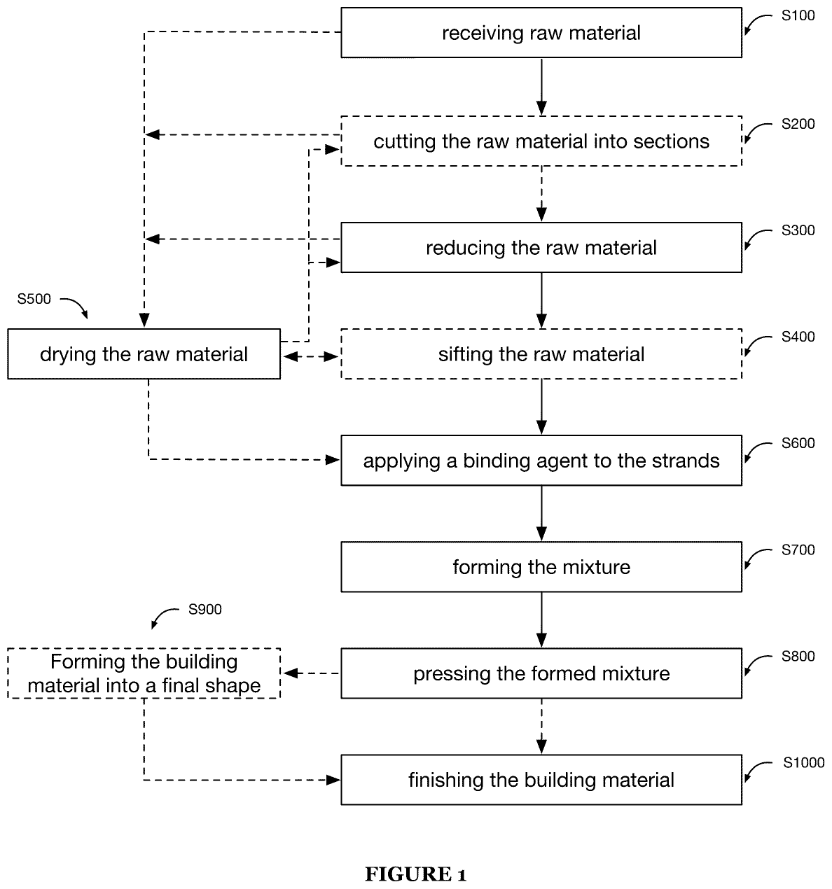

As shown in FIG. 1, a method for manufacturing the alternative building material can include: receiving raw material S100, cutting the raw material into sections (e.g., billets) S200, reducing the raw material S300, optionally sifting the raw material S400, drying the raw material S500, applying a binding agent to the strands S600, forming the mixture S700, pressing the formed mixture S800, optionally forming the building material into a final shape S900, and finishing the building material S1000.

In variants, all and/or portions of the method can be powered by clean energy (e.g., electricity, generated from solar, wind, hydrogen, water, etc.). Additionally or alternatively, traditional energy sources can be used to power steps of the method. All or portions of the method can be performed collocated and/or adjacent to the raw material growing location, or remote from the raw material growing location. All or portions of the method can be performed: in a batch, continuously, and/or otherwise performed.

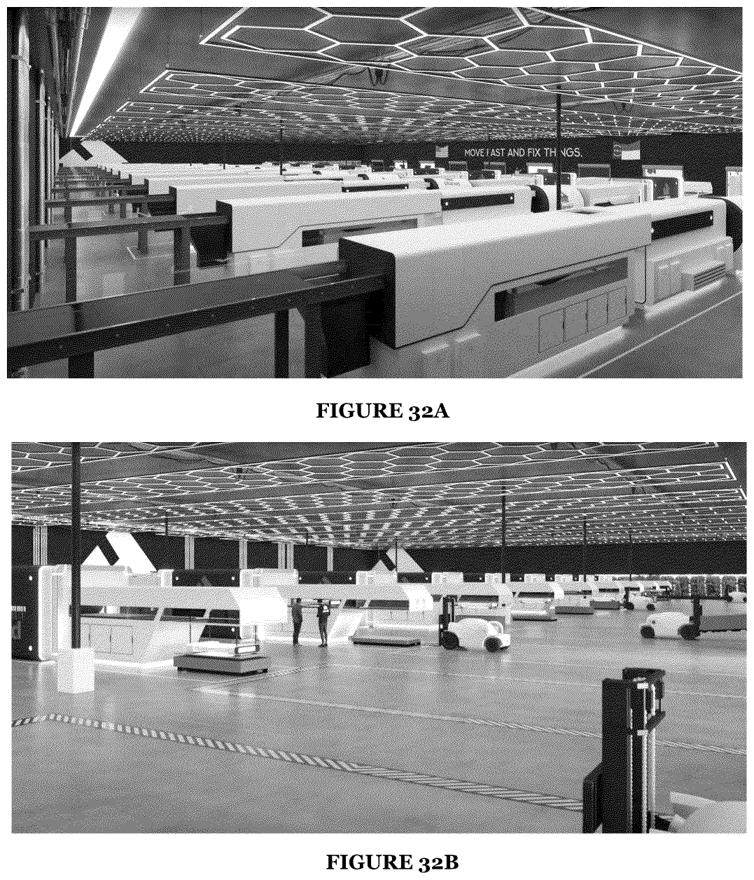

In variants, materials discussed herein can be transported between stations where steps of the method are performed by conveyor belts, chutes, hoppers, vehicles (e.g., dolly, forklift, etc.), see examples in FIGS. 32A and 32B, and/or any other suitable transportation mechanisms. In a specific example, the method can be performed at a continuous manufacturing line including conveyor belts to transport material between adjacent stations (e.g., see FIG. 32A).

However, the method can be otherwise performed.

### 5.1 Receiving Raw Material S100.

Receiving raw material S100 can function to introduce the raw material to the manufacturing system for processing into the building material. S100 can be performed after harvesting the raw material, prior to S200, and/or at any other suitable time. In variants, the raw material can be received: at a site collocated with the growing region, distal from growing region (e.g., at an intermediate processing facility, at a manufacturing site for the building material, etc.), and/or at any other suitable location.

In variants, the raw material can be loaded into a vehicle (e.g., truck, van, train, plane, etc.) and/or alternate transportation system, and transported to a site where S200 is performed (e.g., an intermediate processing facility and/or a manufacturing cite for the building material). At the site, the material can be transported through a material infeed (e.g., a hopper), moved (e.g., by a vehicle, along. conveyor belt, etc.), and/or otherwise transported to a location where S200 is performed.

However, receiving raw material S100 can be otherwise performed.

5.2 Cutting the Raw Material into Sections S200.

Cutting the raw material into sections S200 can function to process the raw material to form the raw material into a shape from which it can be transported, stranded, or otherwise processed in S300. In variants, S200 can be performed after S100 and/or before S100 (e.g., wherein the raw material is received after being cut by an external entity). In variants, S200 can be performed: at a site collocated with the growing region, distal from growing region (e.g., at an intermediate processing facility, at a manufacturing site for the building material, etc.), and/or at any other suitable location. In variants, S200 can be performed: by a human (e.g., a human worker), by a machine, and/or otherwise performed.

S200 can be performed using one or more of: a saw (e.g., band saw, rotary saw, etc.), a splitter (e.g., which separates the material in the direction of the fibers and/or at right angles to a cross sectional surface), a cross-cutter, a blade, a laser cutter, and/or any other cutting device.

In a variant, S200 includes cutting the raw material into billets (e.g., tubular billets, see FIG. 4A, etc.). Billets are preferably of a uniform length, but can alternatively be of varying lengths. In variants, a billet can include a single internode, multiple internodes (e.g., at least one joint or node connecting a first portion of the billet to a second portion of the billet), and/or any other suitable number of internodes or nodes. Additionally or alternatively, S200 can include cutting the raw material lengthwise along a longitudinal axis. Additionally or alternatively, S200 can include cutting the raw material into other forms (e.g., wedges, prisms, etc.).

However cutting the raw material into sections S200 can be otherwise performed.

S200 can additionally or alternatively include pre-processing the material, which can include removing components of the raw material (e.g., leaves, skin, branches, bark, wool, endoplasm, etc.), cleaning the raw material (e.g., with water, with compressed air, with a solvent, etc.), and/or otherwise preparing the raw material. Pre-processing can occur prior to and/or after cutting the raw material.

### 5.3 Reducing the Raw Material S300.

Reducing the raw material S300 can function to produce a plurality of strands (106) of the raw material (102), which can be used as an ingredient of the building material. Optionally, producing a plurality of uniform strands can further function to ensure consistency in thickness, strand density, and material properties of the building material. Preferably, S300 includes producing a plurality of strands of the raw material. Additionally or alternatively, S300 can include splicing, planning, chipping, flaking, pulping, comminuting, and/or otherwise processing the raw material into a form that can be used as an ingredient for the building material. Preferably, S300 includes stranding the sections produced in S200, but can additionally or alternatively include directly stranding an unprocessed version of the raw material.

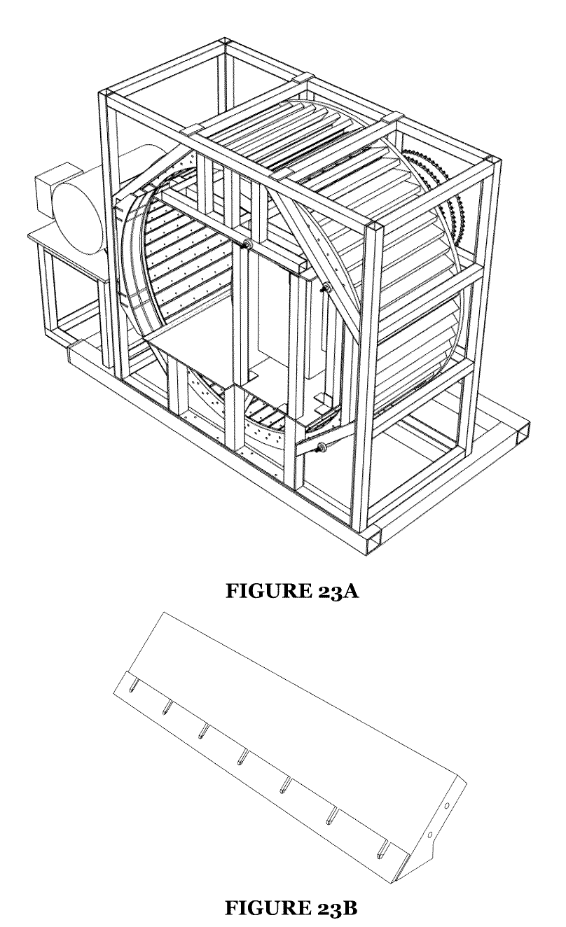

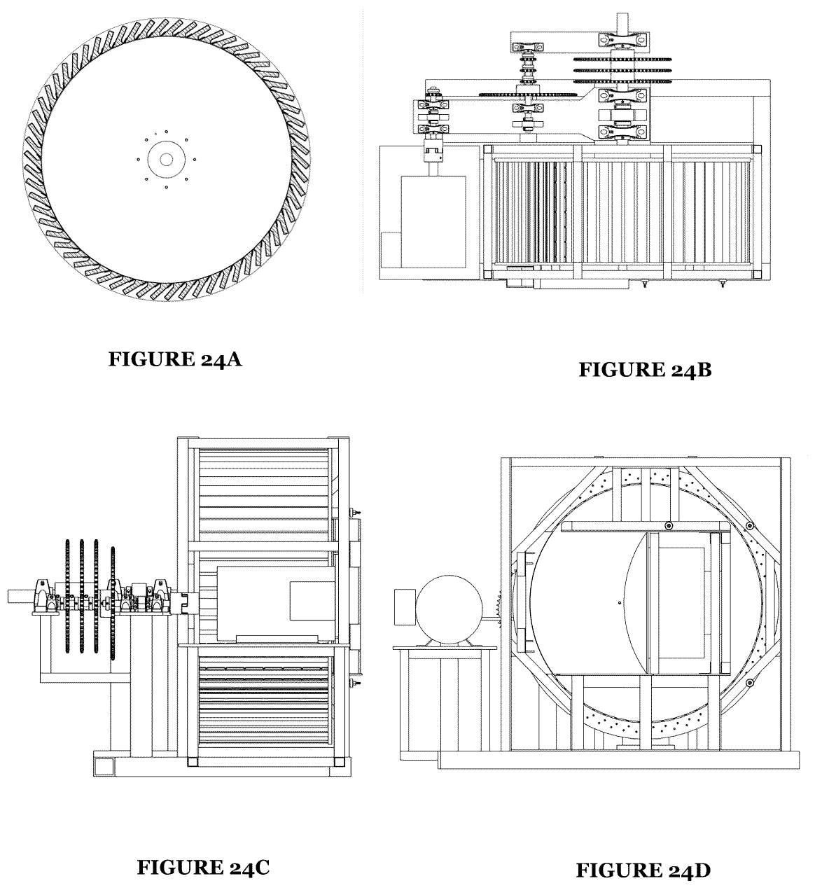

S300 can be performed using one or more of: a stranding machine (e.g., a drum strander, a ring strander, a fan strander, a disc strander, etc.), a flaker machine (e.g., a ring flaker, a drum flaker, etc.), a chipper (e.g., a flywheel chipper, a chipper disk, a drum chipper, etc.), and/or any other suitable device. An example of a drum stranding machine is depicted in FIG. 23A, and a cross-sectional view, top view, side view, and front view thereof are depicted in FIGS. 24A-24D, respectively. In variants, the device can include a plurality of blades (e.g., fewer than 10 blades, 10 or more blades, greater than 20 blades, greater than 30 blades, greater than 40 blades, greater than 50 blades, etc.). Blades can optionally be secured by a blade securing mechanism (e.g., see FIG. 23B). After passing the raw material (or sections thereof) through the stranding device, the strands are preferably between 4 and 18 inches in length, between 0.25 and 1 inch in width, and 0.005 and 0.015 inch in thickness. However, the strands can have any other suitable set of dimensions (e.g., those disclosed herein).

In a first variant, S300 includes stranding the sections of raw material with a cutting apparatus that includes a clamping element and a cutting element (e.g., a drum strander, a drum flaker, etc.). The raw material (e.g., a set of billets of the raw material) can be placed in the cutting apparatus as a stack (e.g., arranged substantially parallel relative to one another), a pile, and/or otherwise arranged within the cutting apparatus. In a first example, the raw material is placed inside a drum that retains the raw material, and the drum rotates relative to a set of blades of the drum flaker to cut the raw material to the produce strands (106). In a second example, the raw material is placed inside a drum that retains the raw material. A blade ring of the cutting apparatus including a set of blades can rotate circumferentially about the retained raw material to cut the raw material to produce the strands (106).

In a second variant, S300 includes stranding the sections of raw material with a cutting apparatus (e.g., a flaker) by placing a stack of raw material into a restraint, retaining the stack of raw material, and moving a set of blades laterally along an axis relative to the stack to cut the raw material to the produce strands (106). The set of blades can move parallel, perpendicular, diagonally, and/or at another orientation relative to a long axis of the raw material (e.g., as defined by the substantially cylindrical shape of the raw material sections).

In a third variant, S300 includes stranding the sections of raw material with a cutting apparatus (e.g., a disc chipper) that includes a rotating disk (e.g., a vertically oriented rotating disk) that cuts the raw material at a direction parallel to the grain direction of the raw material (e.g., parallel to the long axis of the raw material).

However stranding the sections of raw material S300 can be otherwise performed.

### 5.4 Sifting the Raw Material S400.

The method can optionally include sifting the raw material S400 which can function to remove byproducts from the plurality of reduced raw material produced in S300 that are not an intended component of the building material. Byproducts can include strands that do not meet a desired specification (e.g., desired thickness, width, length, rectangular shape, etc.), dust, particulates, stray fibers, and/or any other component. Optionally, strands and other byproducts sorted out can be discarded.

Devices used for sifting the raw material can include: a sieve, a vibrating sifter, an industrial sifter, blowers, and/or any other suitable device. In variants, sifting can be performed: using a sifting device (e.g., holes) in the stranding mechanism, using a sifting device separate from stranding mechanism, by blowing the particulates away, and/or otherwise performed.

In variants, S400 can be performed once or more times: after stranding the raw material S300, during stranding, prior to stranding, and/or at any other suitable time.

In a first variant, S400 is explicitly performed (e.g., by a device configured for sifting, at a station configured for sifting, etc.).

In a second variant, S400 is implicitly performed (e.g., wherein particulates fall out during drying and/or transport).

In a third variant, a transportation means (e.g., a container for transport, a conveyor belt, a filter, etc.) for the strands (e.g., between stations for S300 and S500) can be configured to promote implicit sifting by including mesh, holes, and/or any other egress for particulates.

However sifting the raw material S400 can be otherwise performed.

### 5.5 Drying the Raw Material S500.

Drying the raw material S500 can function to remove excess water from the raw material prior to forming the building material. In a preferred variant, S500 is performed to the strands of raw material prior to binding agent application S600.

Additionally or alternatively, S500 can be performed: after receiving the raw material S100, after cutting the raw material into sections S200, after stranding the sections of raw material, and/or at any other suitable time.

In variants, drying the raw material S500 can be performed by applying a treatment until a target moisture percentage is reached and/or for a specified duration. Drying the raw material S500 can be performed by placing the raw material and/or strands thereof into an oven (curing oven, baking oven, drying oven, furnace, etc.), a rotary drum dryer, a rotary dryer, a vacuum dryer, a tumble dryer, a continuous tray dryer, and/or any other drying device. Additionally or alternatively, drying the raw material S500 can be performed: using a chemical treatment, blowing air (e.g., dry hot air, air above 100° F. with less than 5% humidity, ambient air, etc.) over the raw material, setting the raw material out to dry (e.g., in an ambient environment, in the sun, etc.) for an extended time period (e.g., hours, days, etc.), and/or otherwise performed.

Preferably, the raw material is dried to a target moisture percentage by mass in a range of 5-15%. However, the target moisture percentage can be less than 5%, greater than 15%, and/or any other range therebetween (e.g., 5-10%, 6-11%, 7-12%, 8-13%, 9-14%, 10-15%, etc.). Optionally, the dried strands and/or raw material can be stored (e.g., in a storage container) to maintain the target moisture percentage until a subsequent step (e.g., prior to binding agent application S600, prior to stranding S300, etc.).

In a first variant, S500 is performed after the strands have been sifted (e.g., by using blown air, using an oven, etc.) to remove water content to ensure a proper moisture content for mixing with the binding agent.

In a second variant, S500 includes drying the raw material prior to cutting S200. This can be performed after harvesting and before or after transporting the raw material to a manufacturing facility.

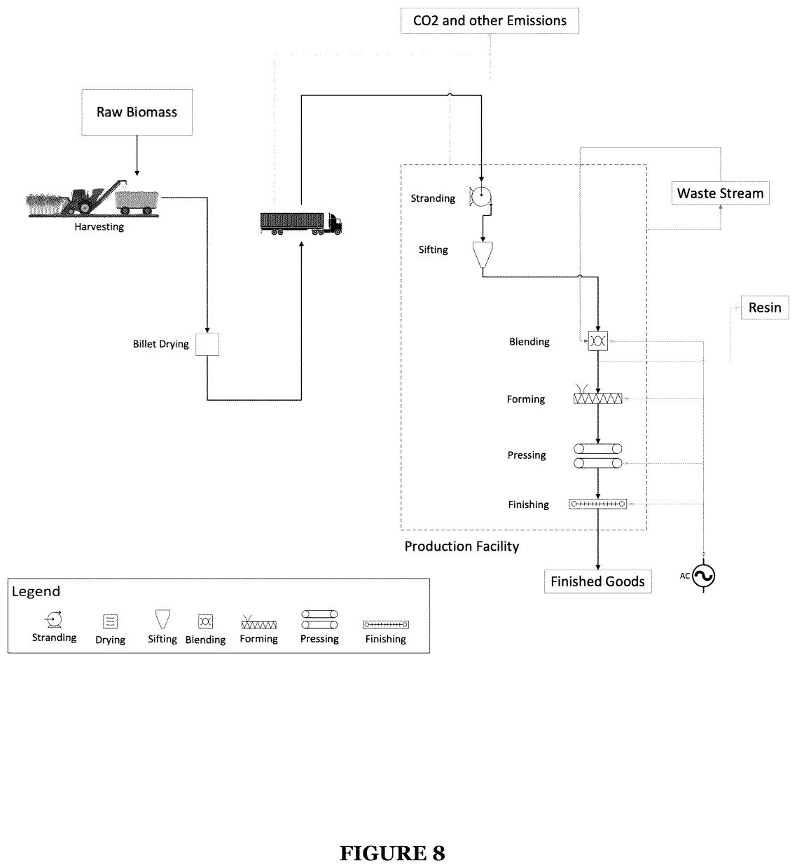

In a third variant, S500 includes drying the raw material prior to stranding. This can be performed after harvesting and before or after transporting the raw material to a manufacturing facility (e.g., see FIG. 8). In variants, the target moisture level can function to ensure that the strands are flat and do not curl up after the billets are cut by the blade.

However drying the raw material S500 can be otherwise performed.

### 5.6 Applying a Binding Agent to the Strands S600.

Applying a binding agent to the strands S600 can function to combine the strands and the binding agent (e.g., a resin such as polymeric diphenylmethane diisocyanate (PMDI) phenol formaldehyde). S600 can produce a composite mixture of strands of raw material and a binding agent. Preferably, the strands are fully coated. Alternatively, the strands can be partially coated, can be fully or partially saturated with the binding agent, and/or the mixture can be otherwise composed.

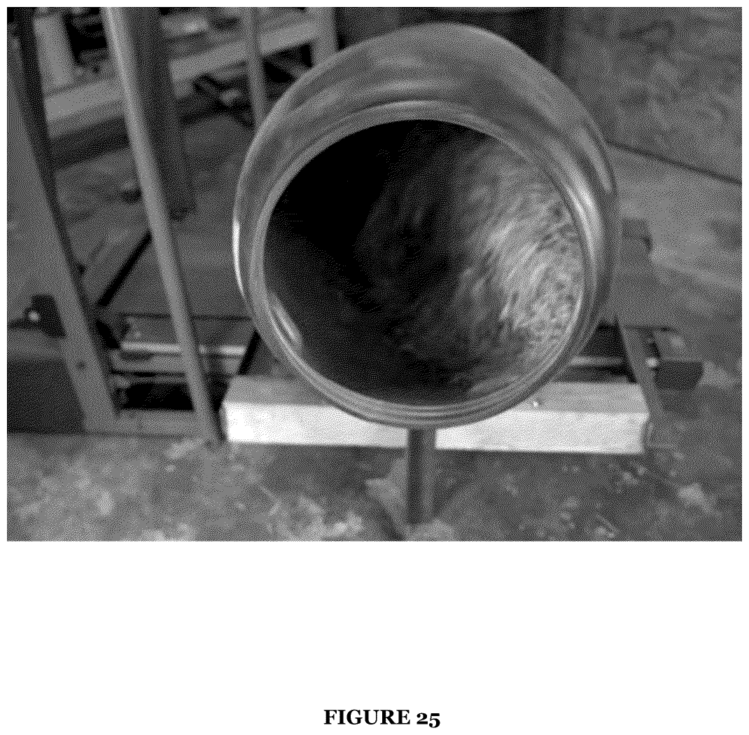

In variants, the strands and binding agent can be combined using a: rotary drum, blending drum, blender, sprayer (e.g., high pressure sprayer, precision spray controller, panel spray system, OSB panel spray system, industrial spray booths, etc.), brush, blending mixer (e.g., see FIG. 25), former (e.g., wherein the binding agent is poured onto the reduced raw material), and/or any other mixing method and/or device.

S600 is preferably performed after drying S500, but can additionally or alternatively be performed after stranding S300, after sifting S400, and/or at any other suitable time. In variants, S600 can be performed at room temperature, at a temperature lower than the binding agent curing temperature (e.g., less than 50 C, less than 100 C, less than 150 C, etc.), and/or at any other suitable temperature.

In variants, S600 can be performed for a duration: that is less than a cure time of the binding agent, less than or equal to a predetermined time (e.g., 5 minutes, 10 minutes, 30 minutes, 60 minutes, etc.), and/or for any other suitable duration.

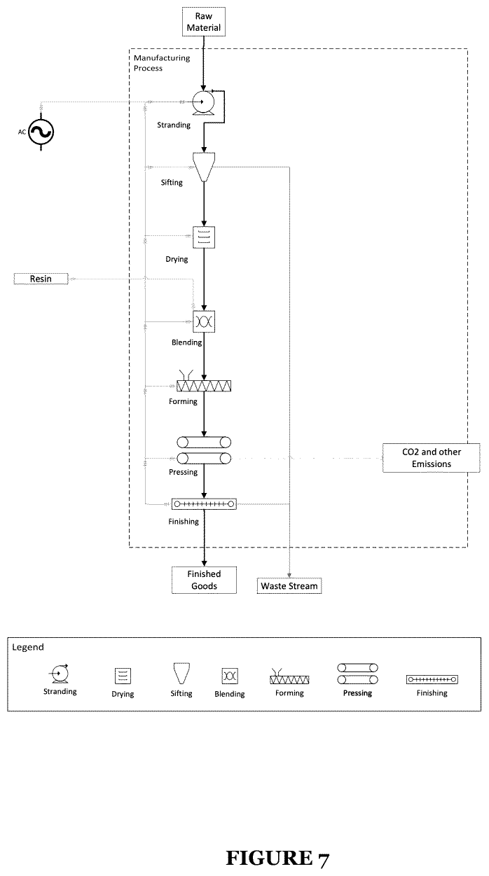

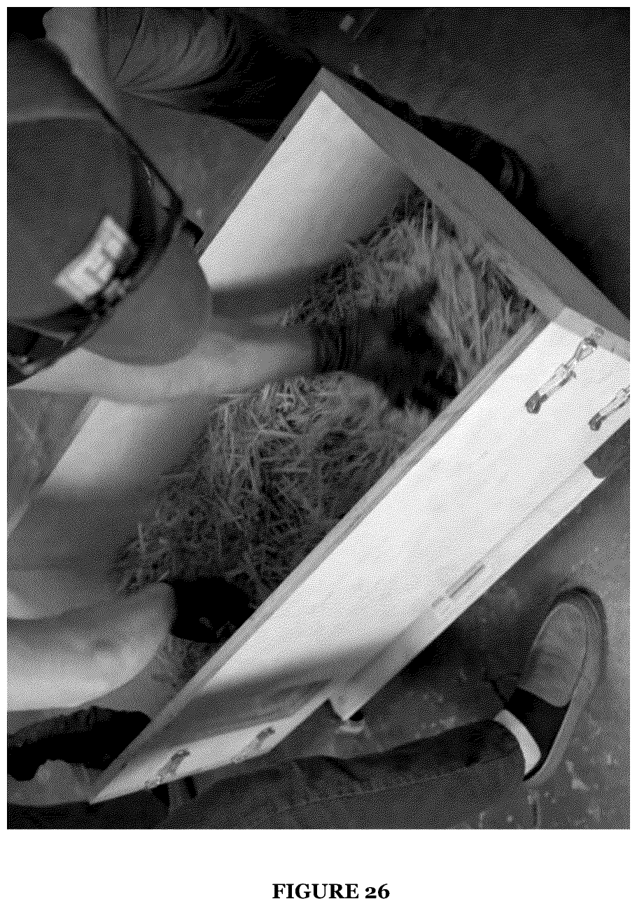

In variants, S600 can optionally include blending (e.g., mixing) one or more of: the strands, the binding agent, additional additives, and/or any other suitable component. Applying the binding agent can be performed prior to blending the binding agent with the strands and/or additional additives (e.g., wherein the binding agent is added to a container holding the strands and/or additional additives, and then the binding agent, strands and/or additional additives are blended), while blending the binding agent with the strands (e.g., see FIG. 7) and/or additional additives, after blending the strands (e.g., blending only the strands, blending the strands with additional additives, see FIG. 8, etc.), and/or otherwise performed. An example of blended strands is shown in FIG. 26.

In a first variant, S600 includes combining the binding agent (e.g., a dry binding agent) with the plurality of strands, mixing the dry binding agent and the plurality of strands into a homogenous mixture, and activating the binding agent. Activating the binding agent can include: heating the mixture, pressing the heated mixture, curing the mixture, adding a solvent (e.g., water, ethanol, etc.) to the mixture, and/or otherwise activating the binding agent.

In a second variant, S600 includes combining the binding agent with the plurality of strands while tumbling the strands. The binding agent can be applied in an atomized form (e.g., atomized resin), a dry binding agent, an inactivated binding agent, a spray, a liquid, and/or in any other form. In a specific example, an atomized resin is released into a container (e.g., a closed container) holding the plurality of strands, and the container tumbles the strands and binding agent to randomly coat the strands with the binding agent.

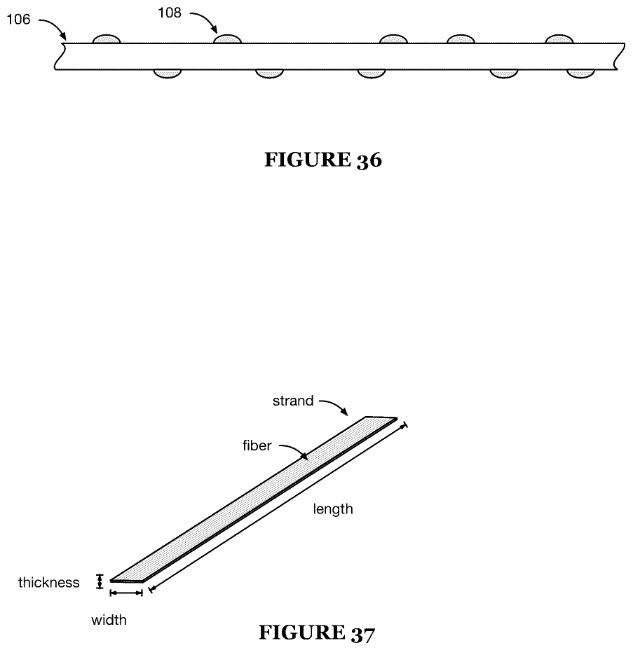

In a third variant, S600 includes spraying the binding agent onto the plurality of strands. In examples, S600 can include spraying the strands a single layer at a time (e.g., spraying one side of the layer, spraying both sides of the layer concurrently and/or simultaneously, etc.), in batches (e.g., while the strands are tumbled), and/or otherwise spraying the strands. The sprayed binding agent can be solid, liquid, gaseous, vapor, and/or sprayed in any other suitable phase. In an example, the binding agent can be applied as beads of binding agent onto a plurality of strand surfaces (e.g., example shown in FIG. 36). Beads can be on the order of microns or millimeters in diameter.

In a fourth variant, S600 includes combining a liquid binding agent with the plurality of strands, mixing the liquid binding agent with the plurality of strands (e.g., into a homogenous mixture), and optionally heating and/or curing the mixture.

S600 can additionally or alternatively include adding additives to the mixture. Additives can be added: to the binding agent (e.g., prior to mixing with the strands), to the reduced raw material or strands (e.g., prior to mixing with the binding agent), to the mixture of the reduced raw material and binding agent (e.g., added simultaneously, added sequentially, etc.), and/or otherwise combined. In examples, the additives can be added using any of the variants and/or examples described for adding the binding agent to the strands in S500. However, adding additives can be otherwise performed.

However, the binding agent can be otherwise applied to the raw material.

### 5.7 Forming the Mixture S700.

Forming the mixture S700 can function to position the composite mixture of strands and binding agent in a desired configuration (e.g., a mat) prior to pressing the mixture in S800. S700 can be performed after S600 (e.g., the mixture is formed into building material form factor), before S600 (e.g., the strands are formed into building material form factor and the binding agent is added after), and/or at any other suitable time.

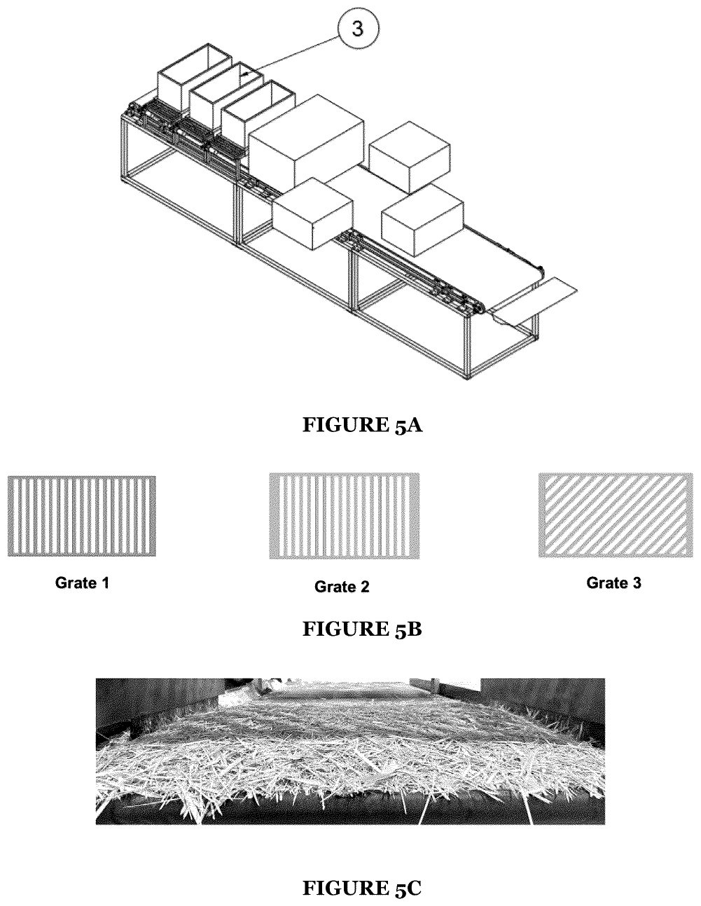

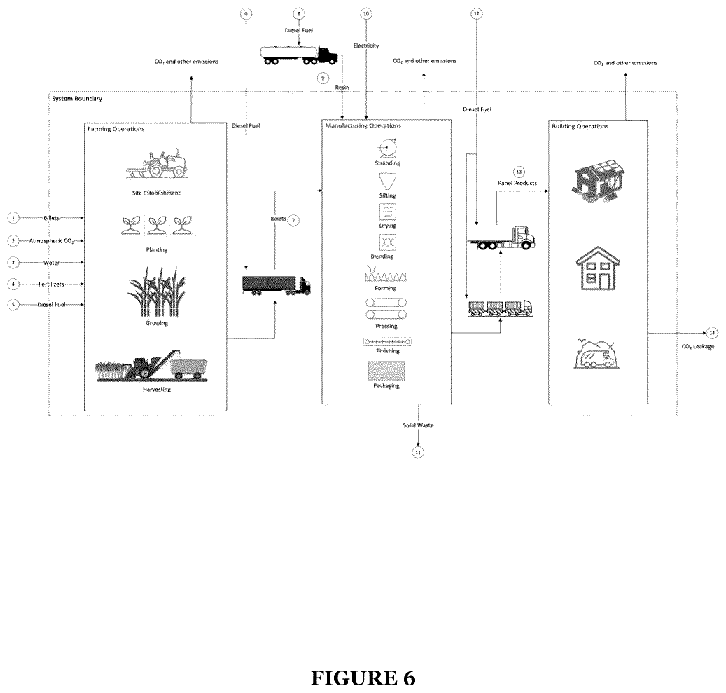

S700 can include passing the mixture (e.g., the composite mixture of strands and binding agent, a mixture of strands, etc.) to a receptacle (e.g., to form a mat). The receptacle can be a rectangular bed, a circular bed, and/or otherwise configured. The receptacle can be static, stationary (e.g., the bed of a conveyor belt), and/or otherwise configured. Preferably the mixture is passed through a forming head of a former (e.g., see example in FIG. 5A), but can additionally or alternatively be selectively poured to evenly distribute the mixture through the bed, dumped into the bed and subsequently redistributed, and/or otherwise passed to the receptacle. The mixture can be poured through a feed hopper, transported along a conveyor belt, and/or fed by a rotating screw feeder, and/or otherwise supplied. Forming the mixture can be performed automatically (e.g., by a forming device) and/or manually (e.g., wherein a human operator pours the mixture through a forming head, etc.).

In variants, the mixture can be continuously passed into a forming device, passed into the forming device in a batch, and/or otherwise placed into the forming device. In examples, batches of about 4.75 kg can be passed into the forming device at a time; however, batches of a greater mass (e.g., about 5 kg, about 5.25 kg, about 5.5 kg, etc.), batches of a smaller mass (e.g., about 4.5 kg, about 4.25 kg, etc.), and/or any other sized batch can be passed into the forming device. The mixture can be fed into the forming device at a controlled rate (e.g., constant rate, variable rate, etc.) and/or at an uncontrolled rate. In a specific example, the former can be supplied with mixture at a rate of about 8 feet per minute; however, the rate can be less than 8 feet per minute, greater than 8 feet per minute, and/or otherwise specified.

In a first variant, S700 includes passing (e.g., pouring) the mixture through a forming head to achieve a substantially uniform thickness layer (e.g., a mat) of the mixture (e.g., see example in FIG. 5C). The forming head can be a set of grates, a baffle, a mesh, a panel, a screen (e.g., a reciprocating screen), and/or any other device configured to selectively control the flow of material. In examples, the forming head can be a grate with a specified quantity of parallel slots (e.g., 11 slots, 12, 13, 14, 15, 16, 17, 18, 19, 20, etc.). In examples, the grate can be a rectangular grate, and the slots can be parallel to, diagonal to, and/or otherwise angled relative to a side of the rectangle (e.g., see examples in FIG. 5B). The area of the slots can vary, but in specific examples can be between 600-700 in² (e.g., between 600-640 in², between 620-660 in², between 640-680 in², between 660-700 in², etc.), less than 600 in², greater than 700 in², and/or otherwise configured (e.g., depending on the capacity of the manufacturing plant). The forming head can be stationary, reciprocating, vibrating, rotating, and/or otherwise configured. In a specific example, a reciprocating forming head may be driven by a crank rocker mechanism attached to a motor.

In a second variant, S700 includes passing the mixture through a set of orienteers (e.g., by a conveyor belt). The orienteers can be a set of rotating disks (OSB orienteers), selective slots, and/or otherwise configured.

In a third variant, S700 includes pouring the mixture into a desired form. In examples, the mixture can be poured by a moving spout that covers the area of the receptacle bed.

In a fourth variant, S700 includes pouring the mixture into the receptacle, and smoothing over the receptacle with one or more rollers to redistribute the mixture into the intended form (e.g., a uniform layer).

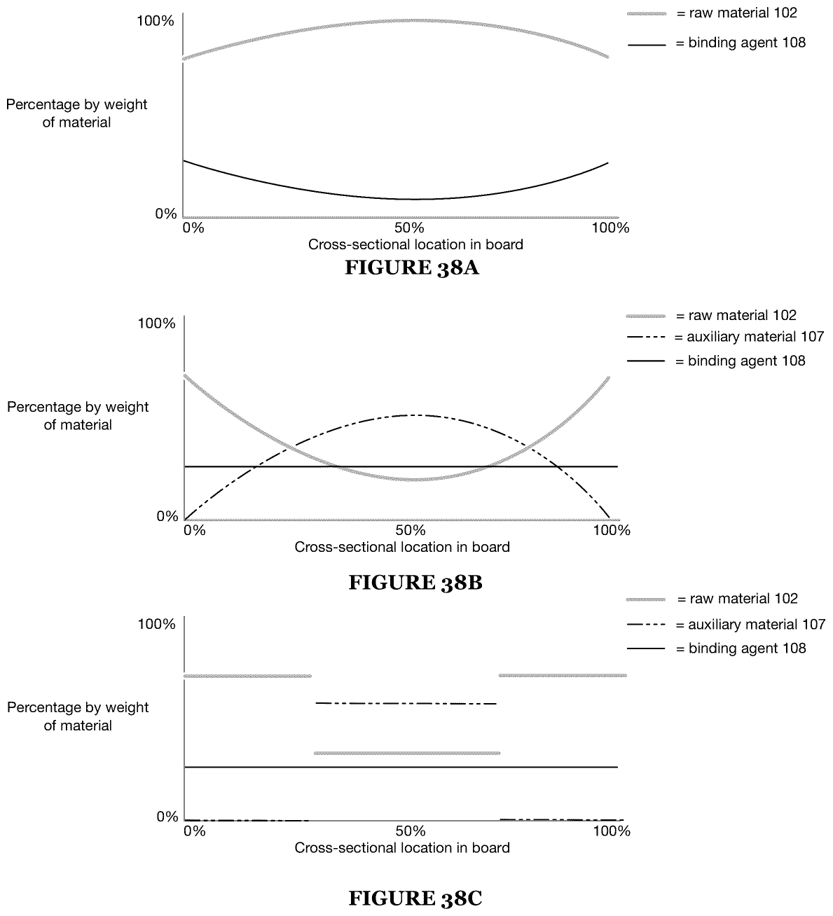

In a fifth variant, S700 includes depositing mixtures with different compositions (e.g., different raw material:binding agent:auxiliary material ratios), strand orientations, and/or other characteristics into different regions of the forming device. The transitions between adjacent mixture compositions can be distinct or gradual (e.g., substantially continuous). For example, different mixtures can be serially deposited into a forming device to form a mat with varying material properties along its thickness (e.g., example shown in FIG. 38C). In a second example, different mixtures can be deposited in different lateral regions to form a mat with varying material properties along its length. In a third example, the mixture composition can be gradually varied as the mixture is poured into the forming device. In an illustrative example, the mixture composition can gradually change from a low-strand ratio to a high-strand ratio (e.g., example shown in FIG. 38A and FIG. 38B). However, the mat composition can be otherwise adjusted.

However, forming the mixture S700 can be otherwise performed.

### 5.8 Pressing the Formed Mixture S800.

Pressing the formed mixture S800 can function to compress the composite mixture (e.g., the mat) into a building material. S800 can include shaping the mixture into a desired shape, density, orientation, and pressing with a specified pressure to produce the final form. In variants, S800 is performed after S700.

Preferably S800 includes pressing the composite mixture (e.g., the mat) into a rigid building material. Alternatively, S800 can include pressing the composite mixture into a semi-rigid and/or flexible building material. The output of 800 can be a structural panel, a beam, and/or any other building material (e.g., any of the building materials disclosed herein).

In variants, S800 can optionally include pre-compressing the composite mixture (e.g., the mat) prior to compressing the composite mixture. In examples, pre-compressing can be performed using any of the techniques used for compressing the composite mixture. In examples, the composite mixture is pre-compressed to a thickness in a range between 2-7 times the final thickness of the final building material (e.g., 2 times, 3 times, 4 times, 4.5 times, 5 times, 5.5 times, between 4-6 times, between 4.8-5.5 times, 6 times, 7 times, etc.); however, the composite mixture can be pre-compressed to less than 2 times the final thickness, greater than 7 times the final thickness, and/or any other suitable thickness. In variants, S800 can include partially compressing the composite material. In such variants, the remainder of compression can be performed in S900 and/or at another suitable time. In variants, the ratio of the pre-compressed thickness to the post-compressed thickness can be 100% (e.g., 1:1), 110%, 120%, 150%, 200%, 300%, 500%, 1000%, a ratio within an open or closed range bounded by the aforementioned values, and/or any other suitable proportion or range of ratios.

In variants, S800 can include pressing the composite mixture produced in S700 with a specific pressure below 400 psi (e.g., in a range between 300-360 psi, 300-330 psi, 310-340 psi, 320-350 psi, 330-360 psi, 320 psi, 330 psi, 340 psi, less than 390 psi, less than 380 psi, less than 370 psi, less than 350 psi, less than 340 psi, etc.). However, the pressure can be greater than or equal to 400 psi (e.g., less than 500 psi, greater than 450 psi, greater than 400 psi, greater than 350 psi, etc.). In examples, the pressure is below 400 psi, whereas typical wood-based composites require at least double that amount of pressure to bind the agent to the woodchips. In variants, the duration at which pressure is applied during S800 can be in a range between 100-220 seconds (e.g., 100-200 seconds, 130-190 seconds, 150-170 seconds, etc.). However, the duration can be less than 100 seconds (e.g., less than 500 seconds, less than 70 seconds, less than 90 seconds, etc.), less than 220 seconds (e.g., less than 200 seconds, less than 180 seconds, less than 160 seconds, etc.), greater than 220 seconds (e.g., greater than 240 seconds, greater than 260 seconds, etc.), and/or any other suitable duration.

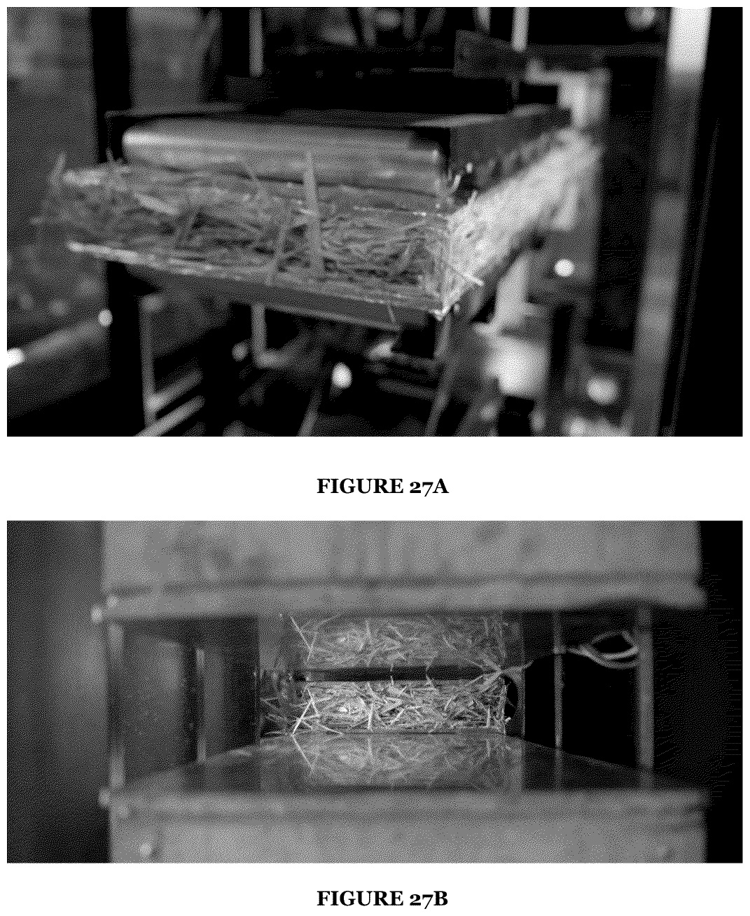

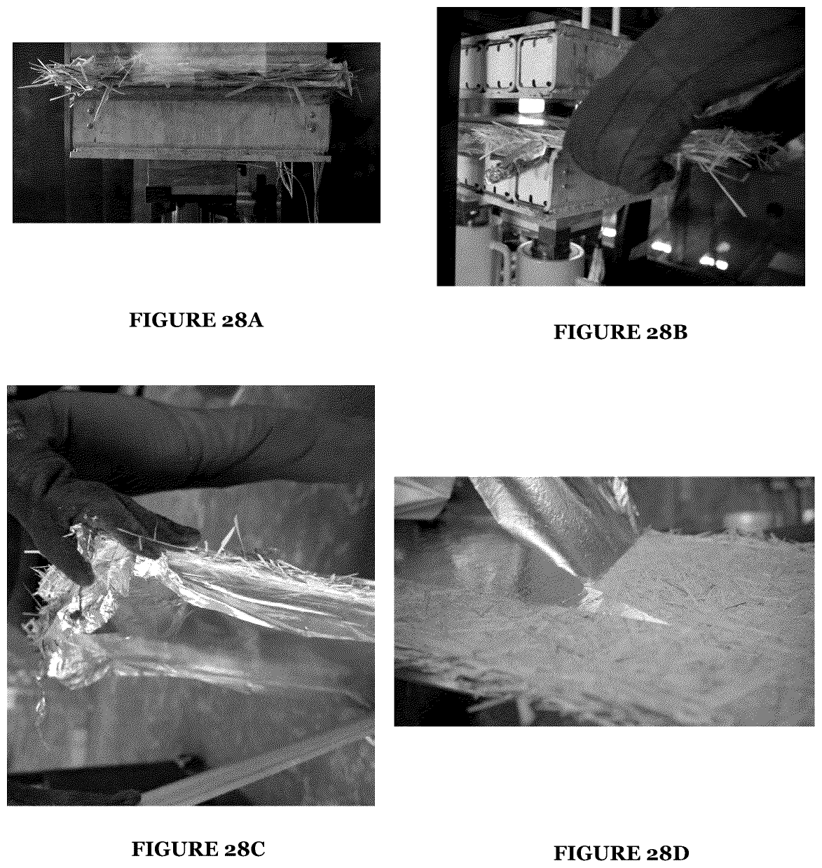

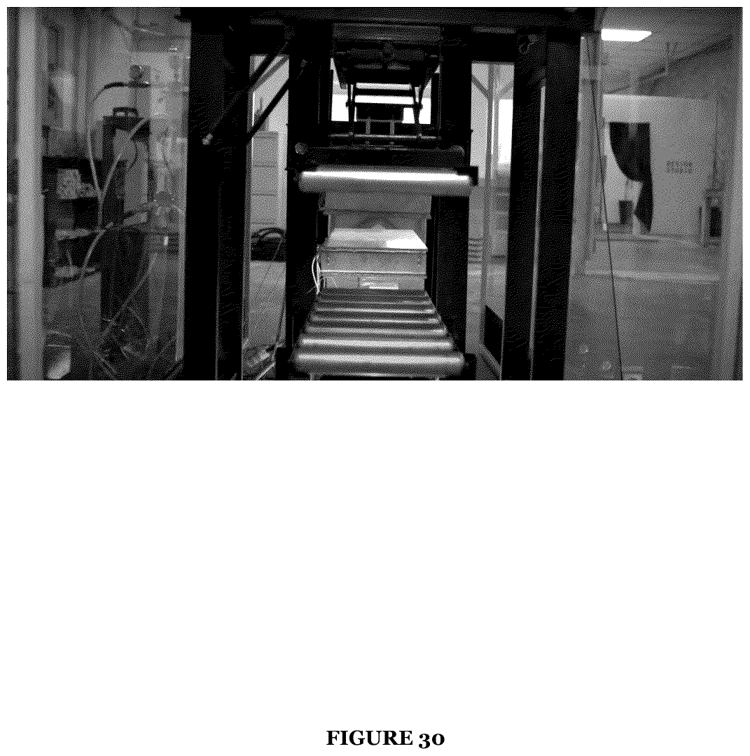

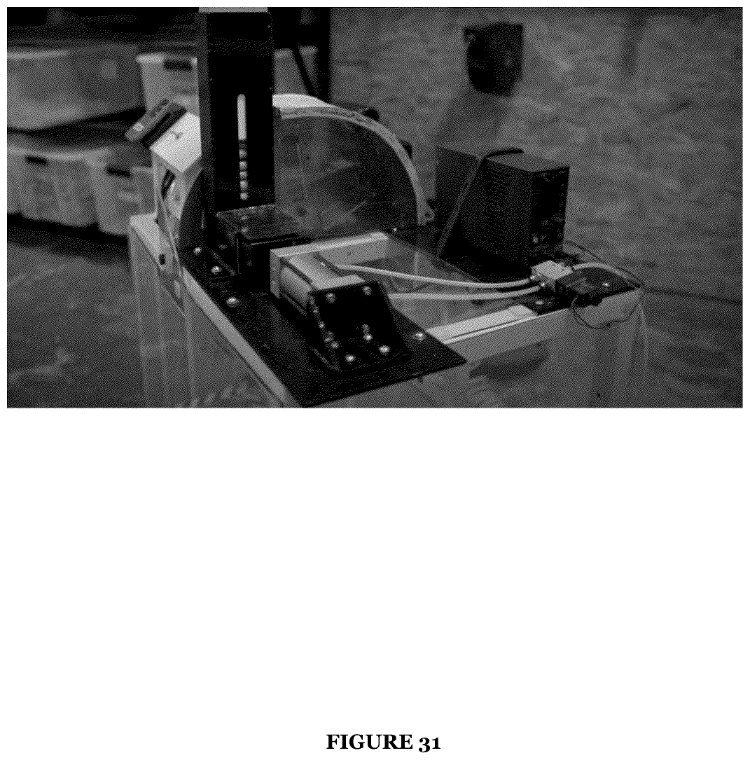

Pressing the formed mixture (e.g., the mat) can be performed using a press (e.g., a hydraulic press, a pneumatic press, etc.) and/or any other suitable device. Pressing can occur with the formed mixture in a mold of sheets, panels, beams, blocks, and/or other suitable materials. Example views of the formed mixture in a press, prior to pressing, are shown in FIG. 27A and FIG. 27B. Example views of the pressed mixture in a press, after pressing, are shown in FIG. 28A and FIG. 30. An example view of removing the pressed mixture from the press is shown in FIG. 28B. Optionally, the formed mixture can be pressed between one or more protective layers, which can include sheets of a material (e.g., plastic, aluminum, foil, etc.), a coating (e.g., chalk, powder, spray, etc.), and/or any other suitable barrier. S800 can optionally include removing the protective layers after pressing. Examples of removing a foil protective layer are shown in FIGS. 28C and 28D.

In variants, S800 can include pressing the composite mixture produced in S700: at room temperature (e.g., in a range between 20° C. and 25° C.), at a controlled range below room temperature (e.g., in a range between 10° C. and 20° C., between 0° C. and 20° C., etc.), at a temperature above room temperature (e.g., in a range between 25° C. and 100° C., between 100° C. and 125° C., between 125° C. and 150° C., between 150° C. and 160° C., between 160° C. and 200° C., above 160° C., above 200° C.,, etc.), and/or at any other suitable temperature. S800 can be performed at an ambient humidity, at a controlled low humidity (e.g., between 25-75% relative humidity, between 35-65% relative humidity, between 0%-35% relative humidity, etc.), and/or at any other suitable humidity.

However pressing the formed mixture S800 can be otherwise performed.

5.9 Optionally Forming the Building Material into a Final Shape S900

Optionally forming the building material into a final shape S900 functions to set the final form of the building material. S900 can be performed continuously (e.g., using pultrusion, etc.), discretely (e.g., using a die-cutter, etc.), and/or in another suitable manner. Examples of final forms can include planar forms, cylindrical forms, round forms, beam-shaped forms (e.g., C-beam, I-beam, etc.), irregular forms (e.g., furniture shapes, etc.), and/or any other suitable form. The final form can be linear in all dimensions, no dimensions, and/or any other suitable subset of dimensions. S900 can be performed by the system component performing S800 (e.g., a press, etc.) but can additionally or alternatively be performed by a separate system component (e.g., a die-cutter, a pultrusion machine, etc.).

In a first variant, S900 can include die-cutting a pressed board into a shape (e.g., a piece of furniture). Die cutting can be performed on a partially-pressed board (e.g., wherein the die-cutting machine output is thinner than the board input to the die-cutting machine), or a fully-pressed board (e.g., wherein the die-cutting machine output is the same thickness as the board input to the die-cutting machine). In variants, the proportion of thicknesses of the input to the die-cutting machine to the output of the die-cutting machine can be 100%, 110%, 120%, 150%, 200%, 300%, 500%, within an open or closed range bounded by the aforementioned values, and/or any other suitable proportion or range of proportions. Die cutting can be performed on a partially cured board (e.g., wherein the die cutter includes a heating element and/or another suitable curing element) or a fully-cured board (e.g., wherein the hardness of the die-cutting machine output is the same as the hardness as the board input to the die-cutting machine). However, S900 can include performing include die-cutting in any other suitable manner.

In a second variant, S900 can include pultruding a partially-pressed and/or partially-cured board into a beam with a desired shape (e.g., a C-beam, an L-beam, an I-beam, etc.). In variants, the proportion of thicknesses of the input to the pultrusion machine (e.g., a board) to the output of the pultrusion machine can be 100%, 110%, 120%, 150%, 200%, 300%, 500%, within an open or closed range bounded by the aforementioned values, and/or any other suitable proportion or range of proportions. S900 preferably includes using a board made up of strands which are unidirectionally oriented (e.g., in the direction of protrusion, etc.) to generate a beam with unidirectionally oriented strands; however, S900 can alternatively include using board with randomly oriented strands and/or strands oriented in another suitable direction. In variants with unidirectionally oriented strands, the usage of unidirectionally oriented strands can give the beam a modulus of elasticity of 2.0 MSI or greater. However, S900 can include performing pultrusion in any other suitable manner. However, any other suitable machine can form the building material into a final shape.

In a third variant, S900 can include combining multiple building material instances into a final form. For example, S900 can include forming a multilayer board from multiple building material instances (e.g., multiple individual boards, multiple single-layer boards). Different building material instances can have the same or different characteristics (e.g., material composition, strand orientation, etc.). In a first example, the different layers can include different raw material:binding agent:auxiliary material ratios. In a second example, the different layers can have comparable raw material:binding agent:auxiliary material ratios, but have different strand orientation. In a third example, the different layers can have different types of raw materials. In an illustrative example, a first layer can include wood strands as the raw material, a second layer can include reed strands as the raw material, and/or a third layer can include a mixture of reed and wood strands as the raw material. However, different layers of the board can be otherwise related. The layers are preferably adhered together (e.g., using a binding agent, using an adhesive, etc.), but can additionally or alternatively be pressed together, manufactured together (e.g., formed together in S700 and pressed into a unitary board in S800), or otherwise manufactured. However, the multilayer board can be otherwise constructed.

S900 can additionally or alternatively include other types of post-processing, including post-forming, thermoforming, hot pressing, roll forming, stretch forming, bending, mandrel forming, and/or any other suitable type of forming or shaping.

However, optionally forming the building material into a final shape S900 can be otherwise performed.

### 5.9 Finishing the Building Material S1000.

Finishing the building material S1000 can function to process the pressed composite mixture to turn it into the final building material and/or an intermediate building material. Finishing processing can include cutting, sealing, labeling, treating, and/or otherwise finishing the building material.

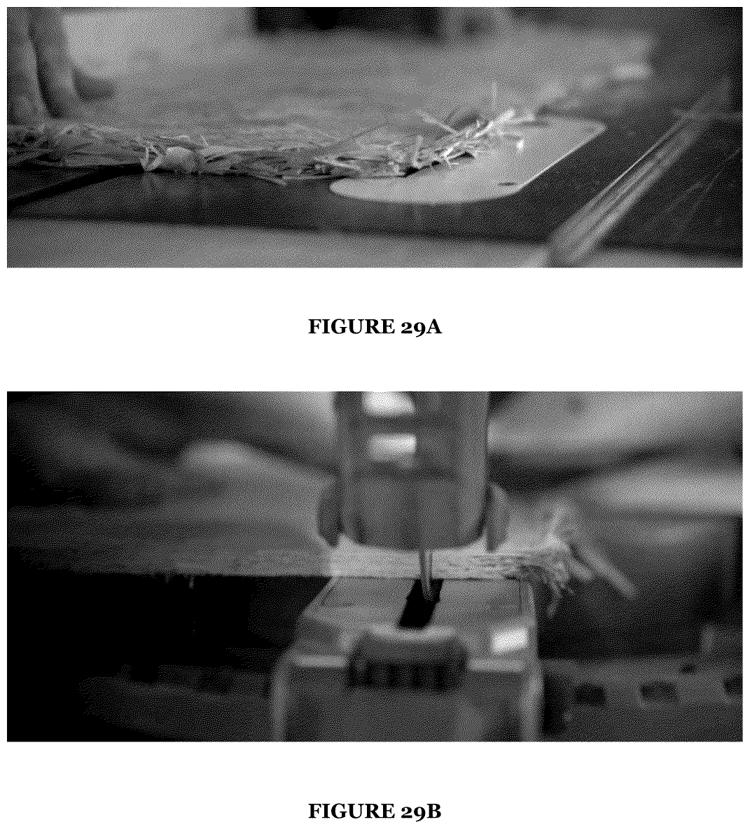

S1000 can include cutting the material into a desired final form a factor (e.g., perpendicular to a length axis, through a thickness of the pressed material, etc.). S1000 can include cutting the material using one or more saws (e.g., band saw, rotary saw, etc.), blades, lasers (e.g., using a laser cutter), and/or any other suitable cutting device. Examples of cutting the material are shown in FIG. 29A and FIG. 29B.

S1000 can additionally or alternatively include sealing the building material (e.g., after cutting the building material, prior to cutting the building material, etc.). Sealing can include applying an additive (e.g., paint, resin, wax, etc.) to all or a portion of the building material exterior (e.g., the broad faces, the edges, the sides, etc.). Sealing can include applying an additional component (e.g., paper, laminate, etc.) to the building material exterior.

S1000 can additionally or alternatively include labeling the building material. Labeling can include stamping, painting, adding print, adding a physical label (e.g., sticker, etc.), ink jetting, and/or otherwise marking the building material.

However finishing the building material S1000 can be otherwise performed.

### 6. Test Results

The following examples are provided to present a complete disclosure and description of how the building materials and methods of manufacture disclosed herein can be built and evaluated, and are not intended to limit the scope of what the inventors regard as their invention. The inventors have made efforts to ensure that the disclosed numbers, such as amounts and temperatures, are accurate. However, it is possible that some errors or deviations may exist, and these should be considered. Unless specifically stated otherwise, all parts are measured by mass, temperature is at an ambient temperature, and pressure is at or near atmospheric pressure.

The following examples (examples 1-7) describe test results for an embodiment of the building material known as a Plantd structural panel with dimensions of 7/16″×4′×8′.

### EXAMPLE 1: UNIFORM STATIC PRESSURE TEST

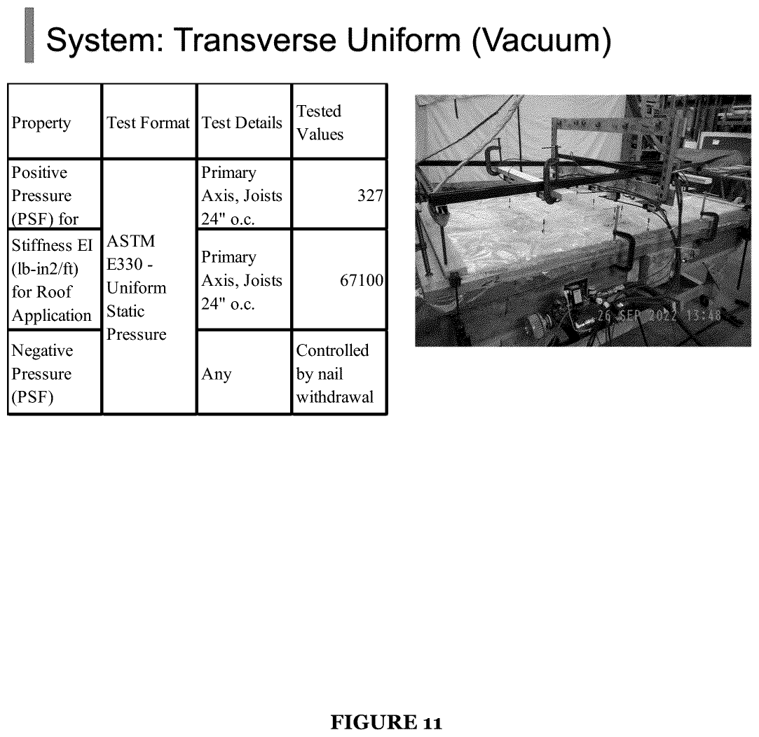

Plantd structural panels were subjected to a standard uniform static pressure test method as outlined by ASTM E330-Uniform Static Pressure (e.g., see FIG. 11). Results are shown in TABLE 1.

TABLE 1
System: Transverse Uniform (Vacuum).

| | | | Tested |
|---|---|---|---|
| Property | Test Format | Test Details | Values |
| Positive Pressure (PSF) | ASTM E330 - | Primary Axis, | 327 |
| for Roof Application | Uniform Static | Joists 24″ o.c. | |
| Stiffness EI (lb-in2/ft) | Pressure | Primary Axis, | 67,100 |
| for Roof Application | | Joists 24″ o.c. | |
| Negative Pressure (PSF) | | Any | Controlled |
| | | | by nail |
| | | | withdrawal |

### EXAMPLE 2: LATERAL SHEAR TEST

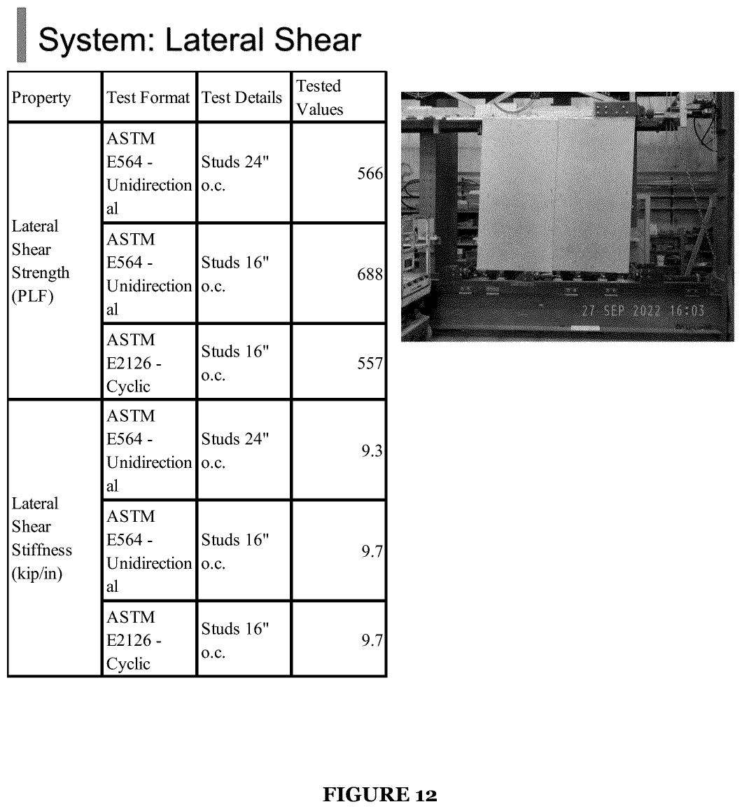

Plantd structural panels were subjected to Lateral Shear Strength and Lateral Shear Stiffness tests according to the standard test methods as outlined by ASTM E564-Unidirectional (for 24″ o.c. studs and 16″ o.c. studs) and by ASTM E2126-Cyclic (for 16″ o.c. studs) (e.g., see FIG. 12). Results are shown in TABLE 2.

TABLE 2
System: Lateral Shear

| Property | Test Format | Test Details | Tested Values |
|---|---|---|---|
| Lateral Shear Strength | ASTM E564 - | Studs 24″ o.c. | 566 |
| (PLF) | Unidirectional | | |
| | ASTM E564 - | Studs 16″ o.c. | 688 |
| | Unidirectional | | |
| | ASTM E2126 - | Studs 16″ o.c. | 557 |
| | Cyclic | | |
| Lateral Shear Stiffness | ASTM E564 - | Studs 24″ o.c. | 9.3 |
| (kip/in) | Unidirectional | | |
| | ASTM E564 - | Studs 16″ o.c. | 9.7 |
| | Unidirectional | | |
| | ASTM E2126 - | Studs 16″ o.c. | 9.7 |
| | Cyclic | | |

### EXAMPLE 3: FLEXURAL STRENGTH TEST

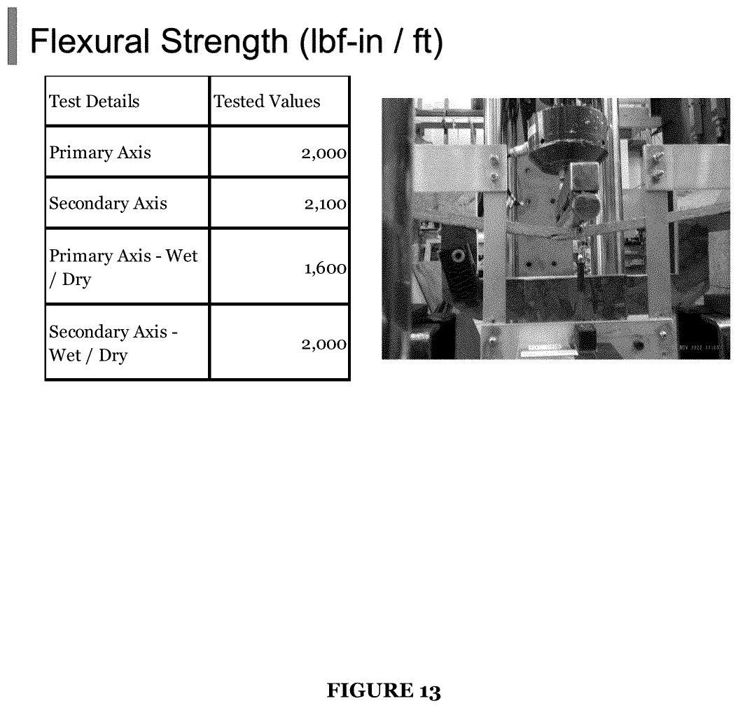

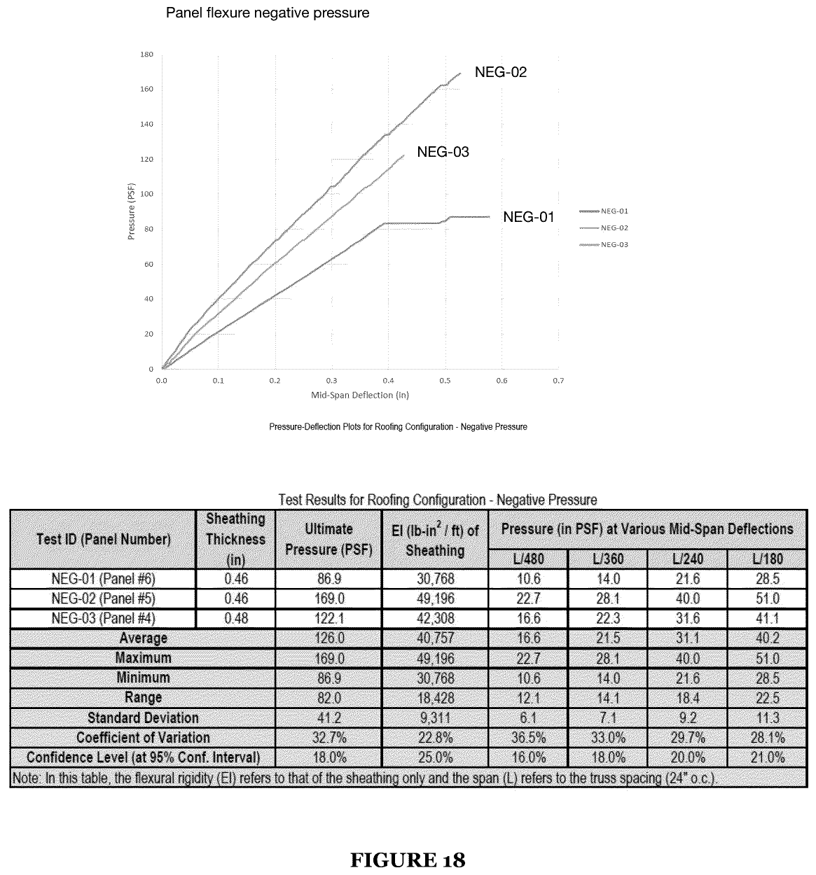

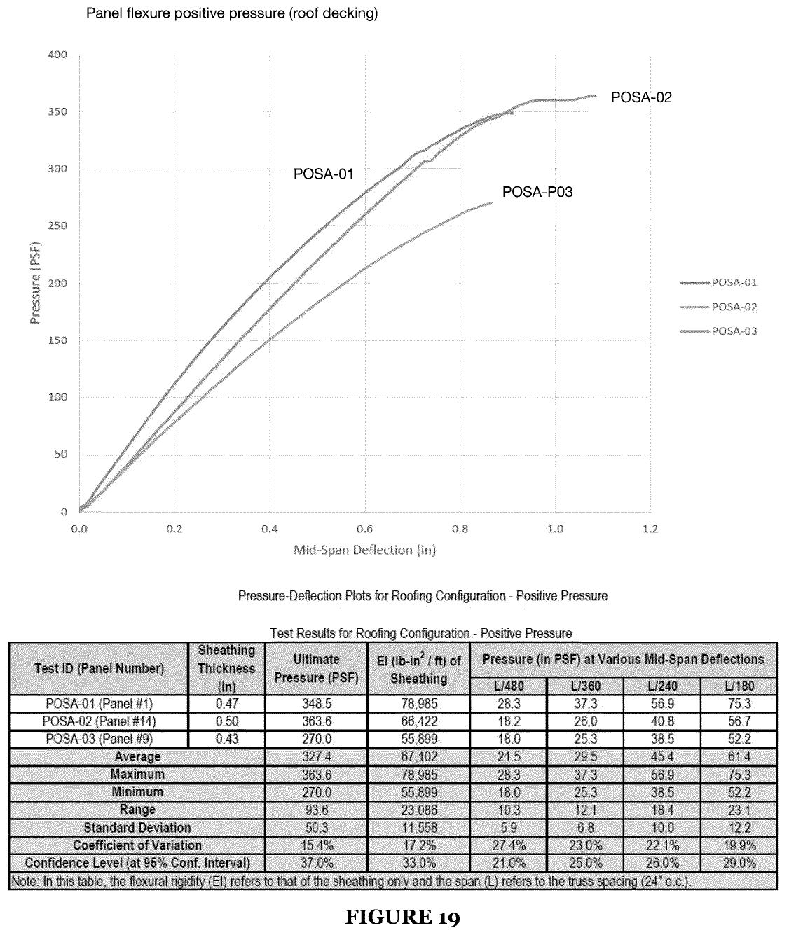

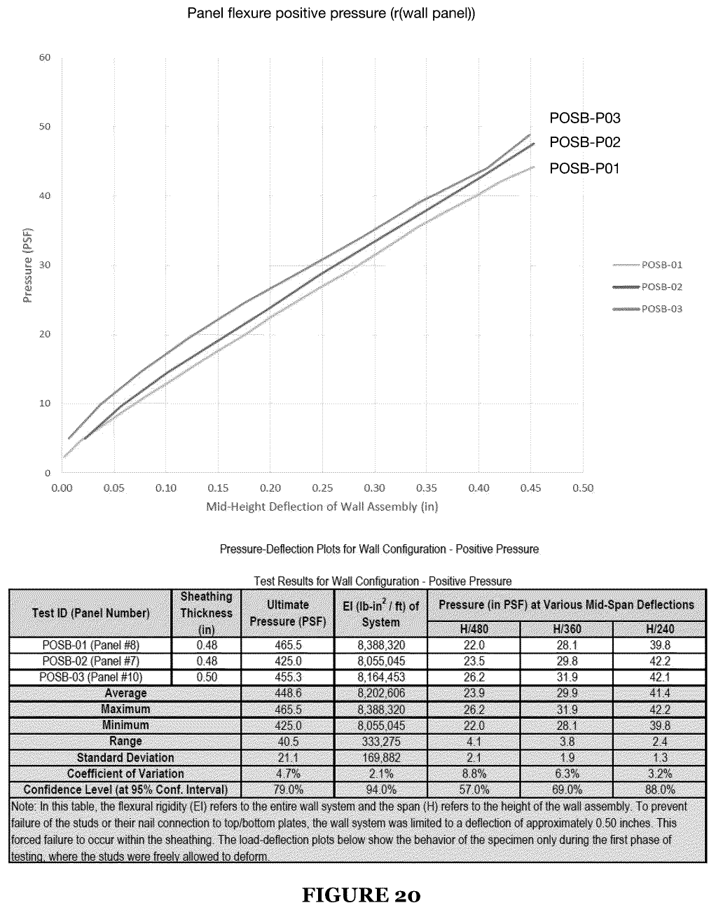

Plantd structural panels were subjected to a 3-point test for flexural strength according to the standard test methods as outlined by ASTM D3043: Standard Test Methods of Structural Panels in Flexure, Method A: Center (e.g., see FIG. 13). Results are shown in TABLE 3. Further examples of test results for panel flexure negative pressure, panel flexure positive pressure for a roof decking embodiment of the alternative building material, and panel flexure positive pressure for a wall panel embodiment of the alternative building material are shown in FIG. 18, FIG. 19, and FIG. 20, respectively.

TABLE 3
Flexural Strength (lbf-in/ft)

| Test Details | Tested Values |
|---|---|
| Primary Axis | 2,000 |
| Secondary Axis | 2,100 |
| Primary Axis - Wet/Dry | 1,600 |
| Secondary Axis - Wet/Dry | 2,000 |

### EXAMPLE 4: FLEXURAL STIFFNESS TEST

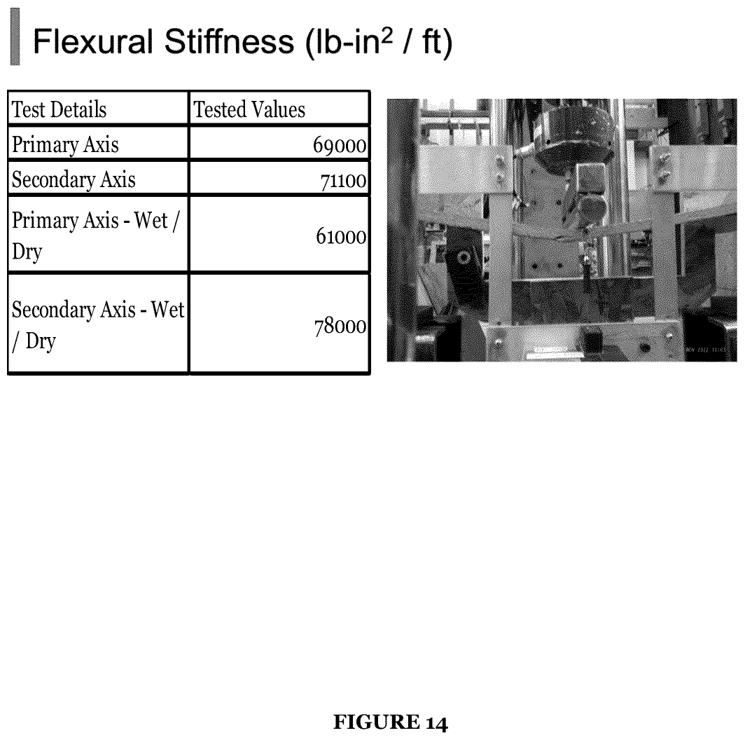

Plantd structural panels were subjected to a Flexural Stiffness test according to the standard test methods as outlined by ASTM D3043 Method A (e.g., see FIG. 14). Results are shown in TABLE 4.

TABLE 4
Flexural Stiffness (lb-in2/ft)

| Test Details | Tested Values |
|---|---|
| Primary Axis | 69,000 |
| Secondary Axis | 71,100 |
| Primary Axis - Wet/Dry | 61,000 |
| Secondary Axis - Wet/Dry | 78,000 |

### EXAMPLE 5: AXIAL TENSION TEST

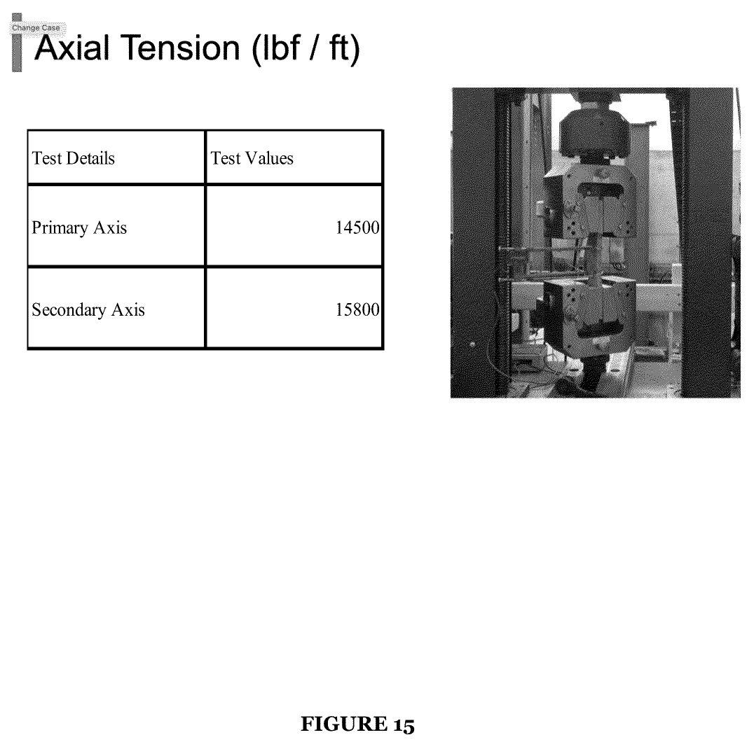

Plantd structural panels were subjected to an axial tension test according to the standard test methods as outlined by ASTM D1037 § 10 (e.g., see FIG. 15). Results are shown in TABLE 5.

TABLE 5
Axial Tension (lbf/ft)

| Test Details | Test Values |
|---|---|
| Primary Axis | 14,500 |
| Secondary Axis | 15,800 |

### EXAMPLE 6: DOWEL BEARING STRENGTH TEST

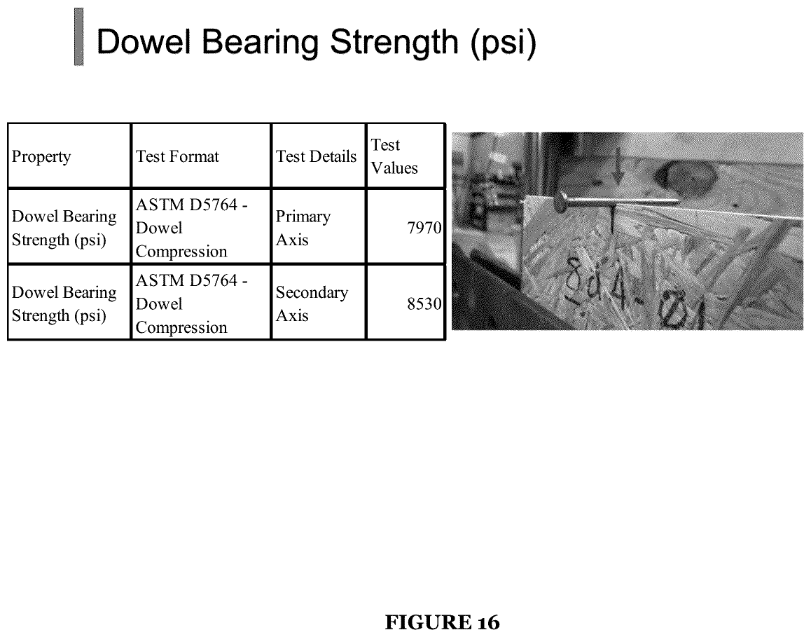

Plantd structural panels were subjected to a standard dowel bearing strength test procedure along the primary and secondary axis as outlined by ASTM D5764—Dowel Compression (e.g., see FIG. 16). Results are shown in TABLE 6.

TABLE 6
Dowel Bearing Strength (psi)

| | | | Test |
|---|---|---|---|
| Property | Test Format | Test Details | Values |
| Dowel Bearing | ASTM D5764 - Dowel | Primary Axis | 7,970 |
| Strength (psi) | Compression | | |
| Dowel Bearing | ASTM D5764 - Dowel | Secondary Axis | 8,530 |
| Strength (psi) | Compression | | |

### EXAMPLE 7: NAIL WITHDRAWAL AND HEAD PULL THROUGH

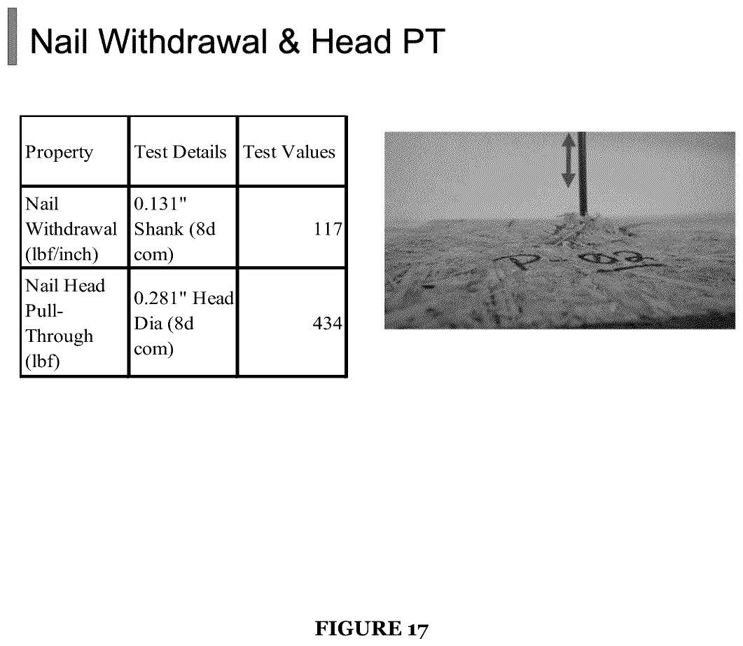

Plantd structural panels were subjected to tests for nail withdrawal in accordance with the ASTM D1037: Standard Test Methods for Evaluating Properties of Wood-Base Fiber and Particle Panel Materials, Section 14: Nail Withdrawal (e.g., see FIG. 17). Plantd structural panels were subjected to tests for head pull-through in accordance with the ASTM D1037: Standard Test Methods for Evaluating Properties of Wood-Base Fiber and Particle Panel Materials, Section 15: Nail-Head Pull-Through (e.g., see FIG. 17). Results are shown in TABLE 7.

TABLE 7
Nail Withdrawal and Head Pull Through

| Property | Test Details | Test Values |
|---|---|---|
| Nail Withdrawal (lbf/inch) | 0.131″ Shank (8d com) | 117 |
| Nail Head Pull-Through (lbf) | 0.281″ Head Dia. (8d com) | 434 |

The following examples (examples 8-12) describe test results for Plantd structural panels of varying dimensions, as described below.

### EXAMPLE 8: DRY 3-POINT BEND TESTING

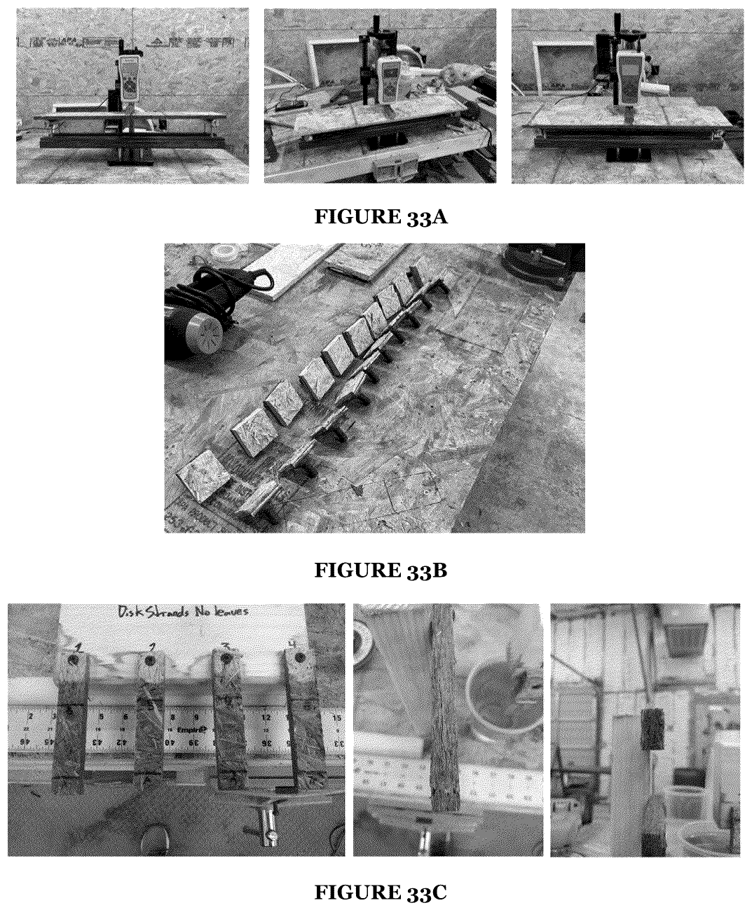

Plantd structural panels were subjected to tests for Dry 3-Point Bend Testing in an internal testing lab (e.g., see example test setup in FIG. 33A). The samples tested were 4.5″L×24″W×˜0.4375″ (+/−0.030″) thick. The sample densities were ˜611.5 kg/m\hat{ }3. 10 samples were taken, and the respective results were averaged together. The inventors found that the average force required to break the samples was about 116 lb/f, and that the average deflection until breakage was about 1.273″.

### EXAMPLE 9: DRY INTERNAL BOND TESTING

Plantd structural panels were subjected to tests for Dry Internal Bond Testing in an internal testing lab (e.g., see example test setup in FIG. 33B). The samples tested were 2″L×2″W×˜0.4375″ (+/−0.030″) thick. The sample densities were ˜611.5 kg/m\hat{ }3. 35 samples were tested, and the respective results were averaged together. The inventors found that the average pull force required to break the bond was about 428.47 lbf.

### EXAMPLE 10: SWELL TESTING

Plantd structural panels were subjected to tests for swell testing in an internal testing lab (e.g., see example test setup in FIG. 33C). The samples tested were 6″L×1″W×˜0.4375″ (+/−0.030″) thick. The sample densities were ˜611.5 kg/m\hat{ }3. 4 samples were tested over a 24 hour period and the respective results were averaged together. The inventors found that the average starting thickness was 0.4368″, and the average ending thickness was 0.5007″. Thus, the inventors calculated a percent swell of 14.64% (e.g., less than 20% swell). In further examples, the building material can be characterized by a percent dimensional swelling that can fall in a range of 15%-35% (e.g., at most 20%, 25%, 30%, etc.) under water saturation over a 24 hour period (e.g., as determined by PS2-18 section 7.9 or equivalent thereof). However, the building material can be characterized by a maximum percent dimensional swelling that is less than 15%, or greater than 35%.

### EXAMPLE 11: RE-DRIED 3-POINT BEND TESTING

Plantd structural panels were subjected to tests for Re-dried 3-Point Bend Testing in an internal testing lab (e.g., see example test setup in FIG. 33A). The samples tested were 4.5″L×24″W×˜0.4375″ (+/−0.030″) thick. The sample densities were ˜611.5 kg/m\hat{ }3. 10 samples were soaked for 24 hours, then allowed to re-dry back to their respective original moisture content. Then the respective results were averaged together. The inventors found that the average thickness of the re-dried samples was about 0.4910″, which indicates an 8% thickness increase. The inventors found that, for the re-dried samples, the average force required to break the samples was about 115.3 lb/f, and the average deflection until breakage was about 1.653″.

### EXAMPLE 12: RE-DRIED INTERNAL BOND TESTING

Plantd structural panels were subjected to tests for Re-dried Internal Bond Testing in an internal testing lab. The samples tested were 2″L×2″W×˜0.4375″ (+/−0.030″) thick. The sample densities were ˜611.5 kg/m\hat{ }3. 12 samples were soaked for 24 hours, then allowed to re-dry back to their respective original moisture content. Then the respective results were averaged together. The inventors found that the average pull force required to break the bond was about 56.417 lbf.

The following examples (examples 13-14) refer to testing performed by a third party on Plantd structural panels. These examples include positive and negative pressure tests in a roof deck assembly, positive pressure on a wall assembly, lateral shear on a wall assembly, (multiple tests of each) and cyclical lateral shear on a wall assembly (single test). The panels outperformed wood-based OSB in bending, nail holding, critical load under lateral shear, and load carrying after critical load under positive pressure and lateral shear. The panels are stiffer, stronger, hold a nail better, and don't fall apart compared to OSB. The panels hold a nail well, which translates to damage tolerance in positive and lateral shear load cases for the wall assembly, especially in cyclic (seismic) load cases. Anecdotally, the panels pulled the nails out of the 2×4's and cracked 2×4's.

### EXAMPLE 13: CYCLIC LOAD TEST FOR SHEAR RESISTANCE OF VERTICAL ELEMENTS

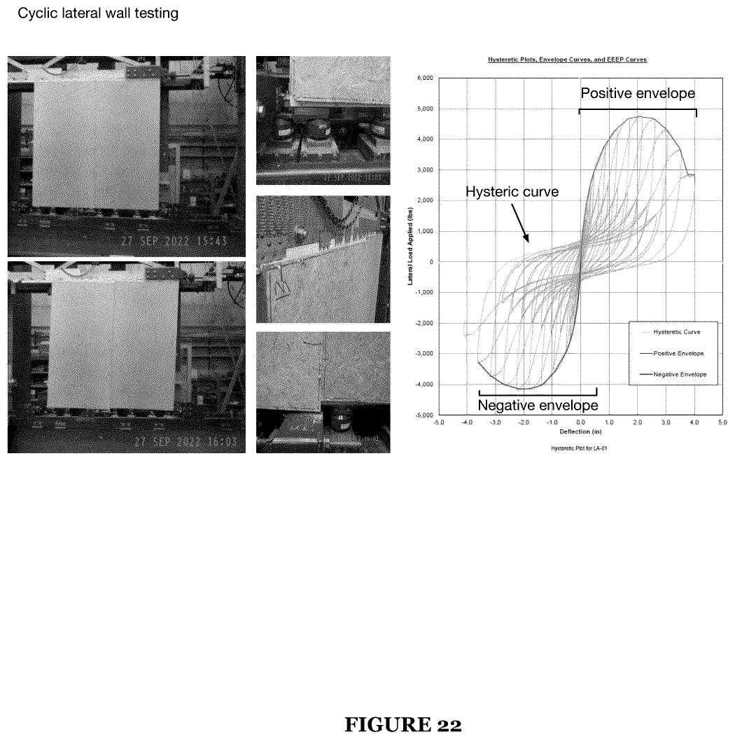

Plantd structural panels were subjected to tests according to the ASTM E2126: Standard Test Methods for Cyclic (Reversed) Load Test for Shear Resistance of Vertical Elements of the Lateral Force Resisting Systems for Buildings. An example test setup and results are shown in FIG. 22. In tests, the panels met the standards laid out in ASTM E2126, and even snapped some nails in half during the cyclic test.

### EXAMPLE 14: LATERAL WALL TESTING

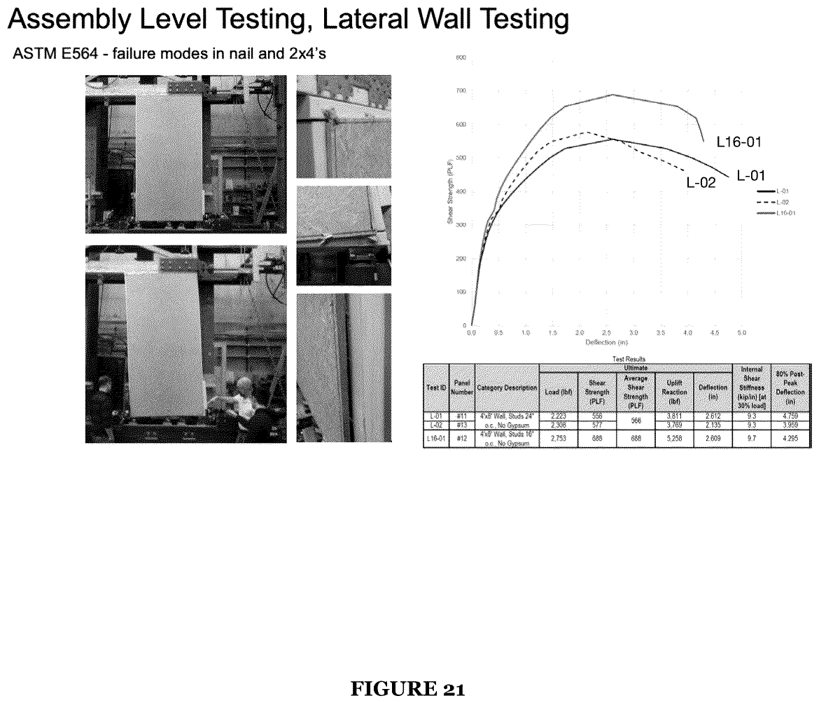

Plantd structural panels were subjected to tests according to the ASTM E564: Standard Practice for Static Load Test for Shear Resistance of Framed Walls for Buildings. In tests, the panels met the standards laid out in ASTM E564, and even outperformed wood-based OSB in lateral shear. An example test setup and results are shown in FIG. 21.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A composite material comprising:
a layer comprising:
reed strands comprising more than 50% by weight of the composite material, wherein each reed strand substantially preserves a natural fiber structure of a reed; and
a binding agent.

2. The composite material of claim 1, wherein the composite material has a cross sectional reed strand density of at least 40 strands per inch.

3. The composite material of claim 1, wherein the reed is from the Arundo genus.

4. The composite material of claim 1, wherein the reed strands are substantially aligned with a longitudinal axis of the composite material.

5. The composite material of claim 1, wherein the composite material comprises less than 7% of the binding agent by weight.

6. The composite material of claim 1, further comprising waste wood.

7. The composite material of claim 6, further comprising a second layer, wherein the waste wood is arranged in the second layer.

8. The composite material of claim 1, wherein the composite material comprises an internal layer, wherein the internal layer and external layer are contemporaneously formed by pressing a single loose mat of material.

9. The composite material of claim 8, wherein the internal layer and the external layer are non-discrete.

10. The composite material of claim 1, wherein the composite material is characterized by a tensile strength of at least 2,650 psi as determined by ASTM D1037.

11. The composite material of claim 1, wherein the composite material is at least one of: an I-beam, L-beam, T-beam, or a C-beam.

12. The composite material of claim 1, wherein the reed strands are not woven.

13. The composite material of claim 1, further comprising at least one of: a tongue, a groove, or a joint.

14. A composite material comprising:
a mat of reed strands bound together by a binding agent;
wherein the reed strands make up over 50% of the mat by weight.

15. The composite material of claim 14, wherein the reed strands have a thickness to length aspect ratio of less than or equal to 1:400.

16. The composite material of claim 14, wherein the reed strands are not oriented relative to an axis of the composite material.

17. The composite material of claim 14, wherein the reed strands comprise strands of Arundo Donax.

18. The composite material of claim 14, wherein the mat comprises waste material.

19. The composite material of claim 14, wherein the mat comprises multiple layers, each comprising a different formulation.

20. The composite material of claim 14, wherein the building material sequesters carbon dioxide from the atmosphere in the reed strands.
